(19) United States
(12) Patent Application Publication
(10) Pub. No.: US 2025/0247631 A1
(43) Pub. Date: Jul. 31, 2025

(54) VEHICLE WINDOW GLASS WITH CAMERA, AND IMAGE PROCESSING METHOD

(71) Applicant: AGC Inc., Tokyo (JP)

(72) Inventors: Mitsuyoshi KOBAYASHI, Tokyo (JP); Kenji KITAOKA, Tokyo (JP); Yoji YASUI, Tokyo (JP)

(73) Assignee: AGC Inc., Tokyo (JP)

(21) Appl. No.: 19/185,570

(22) Filed: Apr. 22, 2025

Related U.S. Application Data
(63) Continuation of application No. PCT/JP2023/041084, filed on Nov. 15, 2023.

(30) Foreign Application Priority Data
Nov. 21, 2022 (JP) 2022-185867

(51) Int. Cl. H04N 23/81; B60H 1/00; B60S 1/02; G02B 5/20; G02B 5/26; H04N 23/23

(52) U.S. Cl. CPC H04N 23/81; B60H 1/00807; G02B 5/208; G02B 5/26; H04N 23/23; B60S 1/023

(57) ABSTRACT

The present invention relates to a camera-equipped vehicular window glass containing: a glass plate formed with a first region that transmits visible light and a second region that has a far-infrared transmittance higher than a far-infrared transmittance of the first region; a far-infrared camera configured to detect a first far-infrared ray transmitted through the second region and to capture a far-infrared image; and an image-processing unit configured to reduce noise mixed in the far-infrared image, which is caused by a second far-infrared ray radiated from an object installed on a side where the far-infrared camera is disposed, relative to the glass plate.

### CROSS-REFERENCE TO RELATED APPLICATIONS

This is a continuation of International Application No. PCT/JP2023/041084 filed on Nov. 15, 2023, and claims priority from Japanese Patent Application No. 2022-185867 filed on Nov. 21, 2022, the entire content of which is incorporated herein by reference.

### TECHNICAL FIELD

The present disclosure relates to a camera-equipped vehicular window glass and an image-processing method.

### BACKGROUND ART

In recent years, various sensors may be attached for the purpose of improving the safety of automobiles. Examples of the sensor attached to the automobile include a camera, a light detecting and ranging (LiDAR), a millimeter wave radar, and an infrared sensor.

Infrared rays are classified into a near-infrared ray (for example, a wavelength of 0.7 μm to 2 μm), a mid-infrared ray (for example, a wavelength of 3 μm to 5 μm), and a far-infrared ray (for example, a wavelength of 8 μm to 13 μm) according to a wavelength band. Examples of the infrared sensor that detects these infrared rays include a touch sensor, a near-infrared camera, or a LiDAR for the near infrared ray, a gas analyzer or a mid-infrared spectroscopic analyzer (functional group analysis) for the mid-infrared ray, and a far-infrared camera for the far-infrared ray. Specific examples of the far-infrared camera include a night vision and a thermo viewer.

Since a window glass of an automobile generally hardly transmits the far-infrared ray having a wavelength of 8 μm to 13 μm, a far-infrared camera has been installed outside a vehicle interior, more specifically, on a front grill in many cases as in, for example, Patent Literature 1. However, in the case where the far-infrared camera is installed outside the vehicle interior, the structure is more complicated in order to ensure robustness, water resistance, dust resistance, and the like, which leads to a high cost. In the case where the far-infrared camera is installed in the vehicle interior and in an operation area of a wiper, the far-infrared camera is protected by the window glass, and dirt and the like can be wiped, so that such a problem can be solved. However, as described above, since there is a problem that the window glass hardly transmits the far-infrared ray, the far-infrared camera has not usually been disposed in the vehicle interior.

In order to meet the above demands, Patent Literature 2 discloses a window member in which a through hole is formed in a part of a window glass and the through hole is filled with an infrared transmissive member.

Patent Literature 1: US2003/0169491A1

Patent Literature 2: GB2271139A

### SUMMARY OF INVENTION

The far-infrared camera disposed on an inner side with respect to the window glass detects the far-infrared ray transmitted through a far-infrared-transmitting region formed in the window glass and captures a far-infrared image. However, the far-infrared ray radiated from any object installed on the inner side with respect to the window glass may be reflected in the far-infrared-transmitting region and may be incident on the far-infrared camera. In this case, noise may be mixed in the far-infrared image captured by the far-infrared camera.

The present disclosure provides a camera-equipped vehicular window glass and an image-processing method capable of reducing noise mixed in a far-infrared image.

In a first aspect, a camera-equipped vehicular window glass includes: a glass plate formed with a first region that transmits visible light and a second region that has a far-infrared transmittance higher than a far-infrared transmittance of the first region; a far-infrared camera configured to detect a first far-infrared ray transmitted through the second region and to capture a far-infrared image; and an image-processing unit configured to reduce noise mixed in the far-infrared image, which is caused by a second far-infrared ray radiated from an object installed on a side where the far-infrared camera is disposed, relative to the glass plate.

A second aspect is based on the camera-equipped vehicular window glass according to the first aspect, which may further include a memory configured to store correction data for reducing the noise. The image-processing unit may reduce the noise by using the correction data read from the memory.

A third aspect is based on the camera-equipped vehicular window glass according to the second aspect, in which the correction data may include mask data of the noise. The image-processing unit may reduce the noise by performing mask-processing on the far-infrared image by using the mask data.

A fourth aspect is based on the camera-equipped vehicular window glass according to the third aspect, which may further include: a reflection plate having a shielding surface that shields a far-infrared ray and a reflection surface that reflects a far-infrared ray; and a drive mechanism configured to move the reflection plate to a first position where the first far-infrared ray is shielded by the shielding surface and the second far-infrared ray is reflected by the reflection surface and incident on the far-infrared camera. The image-processing unit may store, in the memory as the mask data, data of a far-infrared ray detected by the far-infrared camera in a state where the reflection plate is moved to the first position by the drive mechanism.

A fifth aspect is based on the camera-equipped vehicular window glass according to the fourth aspect, in which the drive mechanism may be configured to move the reflection plate to a second position where the first far-infrared ray is incident on the far-infrared camera without being shielded by the shielding surface and the second far-infrared ray is reflected by the second region and incident on the far-infrared camera. The image-processing unit may reduce the noise by performing mask-processing on the far-infrared image by using the updated mask data in a state where the reflection plate is moved to the second position by the drive mechanism.

A sixth aspect is based on the camera-equipped vehicular window glass according to the fifth aspect, in which the image-processing unit may update the mask data by repeating a movement of the reflection plate to the first position and a movement of the reflection plate to the second position by the drive mechanism.

A seventh aspect is based on the camera-equipped vehicular window glass according to the first or second aspect, in which the object or a far-infrared-transmitting filter disposed between the object and the second region may have a first radiation surface that radiates the second far-infrared ray at a first radiation rate and a second radiation surface that radiates the second far-infrared ray at a second radiation rate different from the first radiation rate. The correction data may include data of the first radiation rate and data of the second radiation rate. The far-infrared image may have a first pixel region in which the second far-infrared ray radiated from the first radiation surface at the first radiation rate is captured and a second pixel region in which the second far-infrared ray radiated from the second radiation surface at the second radiation rate is captured. The image-processing unit may extract the second far-infrared ray by using difference data between luminance data of the first pixel region and luminance data of the second pixel region, the data of the first radiation rate, and the data of the second radiation rate.

An eighth aspect is based on the camera-equipped vehicular window glass according to the seventh aspect, in which the image-processing unit may extract the first far-infrared ray by subtracting a product of the extracted data of the second far-infrared ray and the data of the first radiation rate from the luminance data of the first pixel region. Alternatively, the image-processing unit may extract the first far-infrared ray by subtracting a product of the extracted data of the second far-infrared ray and the data of the second radiation rate from the luminance data of the second pixel region.

A ninth aspect is based on the camera-equipped vehicular window glass according to the seventh or eighth aspect, in which the first pixel region and the second pixel region may be adjacent to each other.

A tenth aspect is based on the camera-equipped vehicular window glass according to any one of the seventh to ninth aspects, in which the number of pixels included in the first pixel region may be one, and the number of pixels included in the second pixel region may be one.

An eleventh aspect is based on the camera-equipped vehicular window glass according to the first or second aspect, in which the second region may have a vehicle inner surface and a vehicle outer surface. The vehicle inner surface may have a first reflection surface that reflects the second far-infrared ray at a first reflectance and a second reflection surface that reflects the second far-infrared ray at a second reflectance different from the first reflectance. The vehicle outer surface may have a first transmission surface that transmits the first far-infrared ray at a first transmittance and a second transmission surface that transmits the first far-infrared ray at a second transmittance different from the first transmittance. The correction data may include data of the first reflectance and data of the second reflectance. The far-infrared image may have a first pixel region in which an image of the second far-infrared ray reflected at the first reflectance is captured and a second pixel region in which an image of the second far-infrared ray reflected at the second reflectance is captured. The image-processing unit may extract the second far-infrared ray by using difference data between luminance data of the first pixel region and luminance data of the second pixel region, the data of the first reflectance, and the data of the second reflectance.

A twelfth aspect is based on the camera-equipped vehicular window glass according to the eleventh aspect, in which the image-processing unit may extract the first far-infrared ray by subtracting a product of the extracted data of the second far-infrared ray and the data of the first reflectance from the luminance data of the first pixel region. Alternatively, the image-processing unit may extract the first far-infrared ray by subtracting a product of the extracted data of the second far-infrared ray and the data of the second reflectance from the luminance data of the second pixel region.

A thirteenth aspect is based on the camera-equipped vehicular window glass according to any one of the first to twelfth aspects, in which the image-processing unit may reduce the noise mixed in the far-infrared image, which is caused by the second far-infrared ray being reflected by the second region.

A fourteenth aspect is based on the camera-equipped vehicular window glass according to any one of the first to thirteenth aspects, in which the object may have a thermal conductivity of 150 W/m·K or more and 450 W/m·K or less.

A fifteenth aspect is based on the camera-equipped vehicular window glass according to any one of the first to fourteenth aspects, which may further include a temperature control mechanism configured to control a temperature of the object.

A sixteenth aspect is based on the camera-equipped vehicular window glass according to the fifteenth aspect, in which the temperature control mechanism may include a blower that blows air to the object.

A seventeenth aspect is based on the camera-equipped vehicular window glass according to the fifteenth or sixteenth aspect, in which the temperature control mechanism may include a refrigerant circuit through which a refrigerant circulates.

In an eighteenth aspect, an image-processing method includes:
capturing a far-infrared image by using a far-infrared camera that detects a first far-infrared ray transmitted through a second region that is formed on a glass plate having a first region transmitting visible light and that has a far-infrared transmittance higher than a far-infrared transmittance of the first region; and
reducing noise mixed in the far-infrared image, which is caused by a second far-infrared ray radiated from an object installed on a side where the far-infrared camera is disposed, relative to the glass plate.

The present disclosure can provide a camera-equipped vehicular window glass and an image-processing method capable of reducing noise mixed in a far-infrared image.

### BRIEF DESCRIPTION OF DRAWINGS

FIG. 1 is a cross-sectional view of a configuration in which a far-infrared camera is disposed on an inner side of a glass plate.

FIG. 2 is a diagram illustrating a far-infrared image without noise.

FIG. 3 is a diagram illustrating a far-infrared image in which noise is mixed.

FIG. 4 is a cross-sectional view of a camera-equipped vehicular window glass according to a first embodiment.

FIG. 5 is a cross-sectional view of a camera-equipped vehicular window glass according to a second embodiment.

FIG. 6 is a diagram illustrating an example of a creation status of correction data (mask data).

FIG. 7 is a flowchart illustrating a first example of an image-processing method.

FIG. 8 is a cross-sectional view of a camera-equipped vehicular window glass according to a third embodiment.

FIG. 9 is a flowchart illustrating a second example of the image-processing method.

FIG. 10 is a cross-sectional view of a camera-equipped vehicular window glass according to a fourth embodiment.

FIG. 11 is a diagram illustrating an example of an image-processing method applied to the fourth embodiment.

FIG. 12 is a diagram illustrating another example of the image-processing method applied to the fourth embodiment.

FIG. 13 is a diagram illustrating an example of an arrangement pattern of a plurality of radiation surfaces having different radiation rates of far-infrared rays.

FIG. 14 is a flowchart illustrating an example of the image-processing method applied to the fourth embodiment.

FIG. 15 is a cross-sectional view of a camera-equipped vehicular window glass according to a fifth embodiment.

FIG. 16 is a schematic view illustrating a state where the camera-equipped vehicular window glass according to the present embodiment is mounted on a vehicle.

FIG. 17 is a schematic plan view of the camera-equipped vehicular window glass according to the present embodiment.

FIG. 18 is a cross-sectional view taken along a line A-A in FIG. 17.

FIG. 19 is a cross-sectional view taken along the line A-A in FIG. 17.

FIG. 20 is a cross-sectional view taken along a line B-B in FIG. 17.

FIG. 21 is a schematic view illustrating an example of a state where the camera-equipped vehicular glass according to the present embodiment is attached to a vehicle.

FIG. 22 is a schematic view of a far-infrared-transmitting member viewed from a vehicle outer side in a perpendicular direction.

FIG. 23 is a diagram illustrating an example of a protective member.

FIG. 24 is a diagram illustrating an example of the protective member.

FIG. 25 is a cross-sectional view of another example of the camera-equipped vehicular window glass according to the fourth embodiment.

FIG. 26A is a schematic view of a vehicle inner surface as viewed from a vehicle inner side.

FIG. 26B is a schematic view of a vehicle outer surface viewed from the vehicle outer side.

FIG. 27A is a diagram illustrating a far-infrared image obtained from far-infrared ray transmitted through a second region.

FIG. 27B is a diagram illustrating a far-infrared image obtained from far-infrared ray reflected on the vehicle inner surface.

FIG. 28 is a diagram illustrating another example of the image-processing method applied to the fourth embodiment.

### DESCRIPTION OF EMBODIMENTS

Hereinafter, the present embodiment will be described with reference to the drawings. Note that, for ease of understanding, the scale of each part in the drawings may be different from the actual scale. The direction terms “parallel”, “right angle”, “orthogonal”, “horizontal”, “vertical”, “up and down”, “left and right” and the like, and the terms “same” and “equal” and the like allow a deviation to the extent that the operation and effect of the embodiment are not impaired. The shape of a corner portion is not limited to a right angle, and may be rounded in an arcuate shape. The term “overlapping” may include a meaning of partial overlapping. An X direction, a Y direction, and a Z direction represent a direction parallel to an X axis, a direction parallel to a Y axis, and a direction parallel to a Z axis, respectively. The X direction, the Y direction, and the Z direction are orthogonal to one another. An XY plane, a YZ plane, and a ZX plane represent a virtual plane parallel to the X direction and the Y direction, a virtual plane parallel to the Y direction and the Z direction, and a virtual plane parallel to the Z direction and the X direction, respectively.

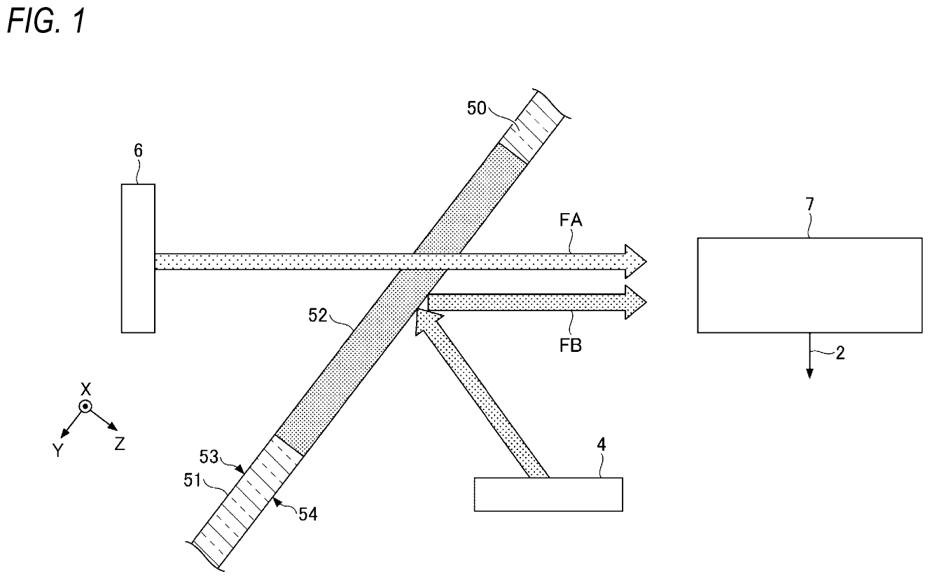

FIG. 1 is a cross-sectional view of a configuration example in which a far-infrared camera is disposed on an inner side of a glass plate. In this example, the X direction represents a direction parallel to a horizontal plane (horizontal direction). The Y direction represents a direction along an outer surface 53 or an inner surface 54 of a glass plate 50. The Z direction represents a direction along a thickness direction of the glass plate 50.

The glass plate 50 is a glass member formed with a first region 51 that transmits visible light and a second region 52 that transmits a far-infrared ray. The second region 52 has a far-infrared transmittance higher than that of the first region 51.

A far-infrared camera 7 is disposed on an inner side with respect to the glass plate 50. The far-infrared camera 7 detects a far-infrared ray FA radiated from an object (subject 6) present on an outer side of the glass plate 50. The far-infrared camera 7 captures a far-infrared image 2 by detecting the far-infrared ray FA transmitted through the second region 52 from the outer side to the inner side of the glass plate 50. The far-infrared image is also referred to as a thermal image.

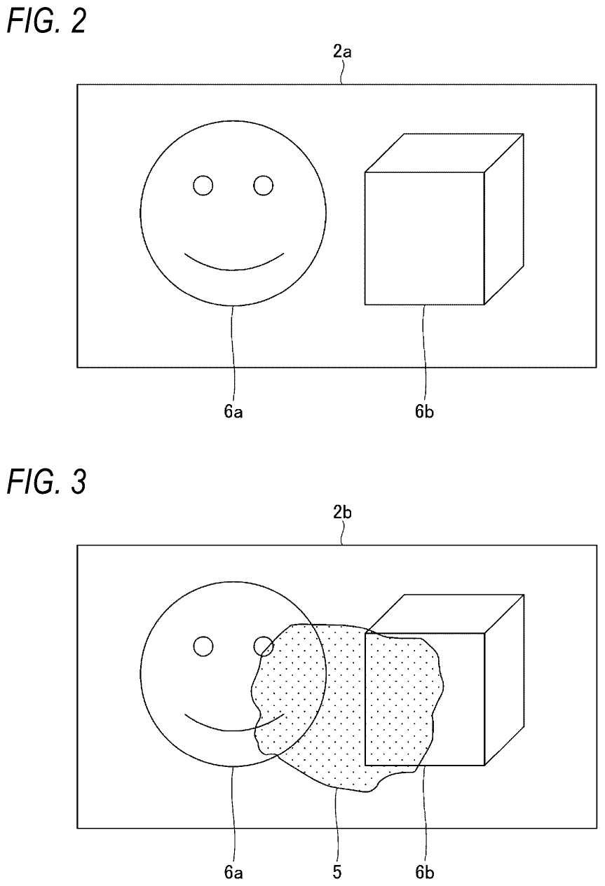

FIG. 2 is a diagram illustrating a far-infrared image captured by a far-infrared camera. It is ideal that only subjects 6a and 6b present on the outer side of the glass plate 50 appear in an far-infrared image 2a captured by the far-infrared camera 7.

However, as illustrated in FIG. 1, a far-infrared ray FB radiated from any object 4 installed on the inner side with respect to the glass plate 50 may be incident on the far-infrared camera 7 directly or after being reflected. For example, the far-infrared ray FB may be reflected by the first region 51 or the second region 52 of the glass plate 50 and incident on the far-infrared camera 7. In this case, as illustrated in FIG. 3, noise 5 generated by the incidence of the far-infrared ray FB may be mixed in a far-infrared image 2b captured by the far-infrared camera 7. Such noise 5 is also called an artifact. The noise 5 is a reflection image that appears in the far-infrared image 2b in various shapes such as a streaky shape and a stripe pattern.

In the case where the noise 5 is present in the far-infrared image 2b, a computer using the far-infrared image 2b may erroneously perceive a non-existent object as being present between the subjects 6a and 6b and the glass plate 50. Therefore, it is preferable to reduce the noise 5 mixed in the far-infrared image 2.

Next, a camera-equipped vehicular window glass and an image-processing method capable of reducing noise mixed in a far-infrared image will be described.

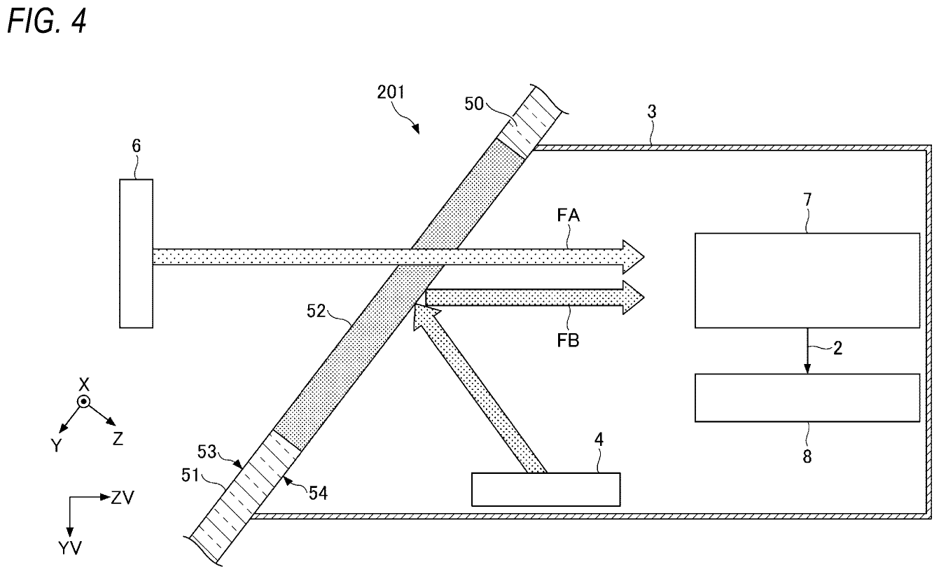

FIG. 4 is a cross-sectional view of a camera-equipped vehicular window glass according to a first embodiment. A camera-equipped window glass 201 illustrated in FIG. 4 is an example of the camera-equipped vehicular window glass. In this example, the X direction represents a direction parallel to the horizontal plane (horizontal direction). The Y direction represents a direction along the outer surface 53 or the inner surface 54 of the glass plate 50. The Z direction represents a direction along the thickness direction of the glass plate 50. AZV direction represents a direction from a vehicle outer side toward a vehicle inner side with respect to the glass plate 50 in a state where the camera-equipped window glass 201 is attached to the vehicle. A YV direction represents a direction from a vehicle upper side toward a vehicle lower side along a vertical direction perpendicular to the horizontal plane in a state where the camera-equipped window glass 201 is attached to the vehicle.

The camera-equipped window glass 201 includes the glass plate 50, the far-infrared camera 7, an attachment 3, and an image-processing unit 8. The object 4 is present on a side where the far-infrared camera 7 is disposed, relative to the glass plate 50.

The glass plate 50 is a vehicular window glass having the outer surface 53 facing the vehicle outer side and the inner surface 54 facing the vehicle inner side. The outer surface 53 is a first main surface facing the vehicle outer side in a state where the glass plate 50 is attached to the vehicle. The inner surface 54 is a second main surface facing the vehicle inner side in a state where the glass plate 50 is attached to the vehicle.

The glass plate 50 is a glass member formed with the first region 51 that transmits visible light and the second region 52 that transmits a far-infrared ray. The second region 52 has a far-infrared transmittance higher than that of the first region 51. The first region 51 hardly transmits a far-infrared ray, but may transmit a far-infrared ray at a transmittance sufficiently lower than the far-infrared transmittance of the second region 52.

The far-infrared camera 7 is disposed on the vehicle inner side with respect to the glass plate 50. The far-infrared camera 7 detects the far-infrared ray FA radiated from an object (subject 6) present on the outer side of the glass plate 50. The far-infrared camera 7 detects the far-infrared ray FA transmitted through the second region 52 from the outer side to the inner side of the glass plate 50, and captures the far-infrared image 2 in which a detection result for the far-infrared ray FA is reflected. The far-infrared ray FA is an example of a first far-infrared ray.

The attachment 3 is a component that directly or indirectly fixes the far-infrared camera 7 to the glass plate 50. Specific examples of the attachment 3 include a cover that covers the far-infrared camera 7 and a bracket that supports the far-infrared camera 7.

The object 4 is installed on a side where the far-infrared camera 7 is disposed, relative to the glass plate 50. The object 4 is a heat source that radiates the far-infrared ray FB. The far-infrared ray FB is an example of a second far-infrared ray. The object 4 is positioned at a position where the far-infrared ray FB radiated therefrom is reflected by the second region 52 and incident on the far-infrared camera 7. The object 4 may be positioned at a position where the far-infrared ray FB radiated therefrom is reflected by the first region 51 or a member different from the glass plate 50 and incident on the far-infrared camera 7, or may be positioned at a position where the far-infrared ray FB radiated therefrom is directly incident on the far-infrared camera 7. The object 4 may be a component covered by the attachment 3 functioning as a cover, or may be a part or all of the attachment 3.

Note that, the object 4 may be a component of the camera-equipped window glass 201 or may not be a component of the camera-equipped window glass 201. For example, the object 4 may be a component or an occupant present in the vehicle interior.

The image-processing unit 8 includes an image-processing circuit that performs image-processing of reducing the noise 5 (see FIG. 3) mixed in the far-infrared image 2, which is caused by the far-infrared ray FB radiated from the object 4 being reflected by the second region 52. The image-processing circuit may perform image-processing of reducing the noise 5 mixed in the far-infrared image 2, which is caused by the far-infrared ray FB being reflected by the first region 51 or a member different from the glass plate 50. The image-processing circuit may perform image-processing of reducing the noise 5 mixed in the far-infrared image 2, which is caused by the far-infrared ray FB being directly incident on the far-infrared camera 7. The “reducing the noise 5” may include the meaning of “removing the noise 5 from the far-infrared image 2”. When the image-processing unit 8 provides the far-infrared image 2 with reduced noise 5 to a computer (not illustrated), for example, the likelihood that the computer erroneously recognizes a non-existent object as being present between the subject 6 and the glass plate 50 is reduced.

In this way, since the camera-equipped window glass 201 according to the present embodiment includes the image-processing unit 8, the noise 5 mixed in the far-infrared image 2, which is caused by the far-infrared ray FB radiated from the object 4 being incident on the far-infrared camera 7 directly or after being reflected by the second region 52 or the like, can be reduced. Accordingly, the noise 5 is reduced even when the far-infrared ray FB changes depending on a solar radiation status during traveling of the vehicle.

The image-processing function of the image-processing unit 8 is implemented by, for example, a processor such as a central processing unit (CPU) operating according to a program readably stored in a memory. The program that implements the processing performed by the image-processing unit 8 may be provided by, for example, a recording medium or a network.

Note that, in this example, the image-processing unit 8 is a component of the camera-equipped window glass 201, but may not be a component of the camera-equipped window glass 201. For example, the image-processing unit 8 may be an electronic control device mounted on the vehicle at a position away from the camera-equipped window glass 201 or a built-in component thereof. In addition, the image-processing unit 8 may be provided in a server away from the vehicle, and may transmit the far-infrared image 2 with reduced noise 5 to the server via a communication line. Alternatively, the image-processing unit 8 may be built in the far-infrared camera 7.

In the case where the object 4 has a thermal conductivity of, for example, 150 W/m·K or more and 450 W/m·K or less, a temperature distribution of the object 4 approaches uniformity, and thus the noise 5 mixed in the far-infrared image 2 is reduced. From the viewpoint of reducing the noise 5 mixed in the far-infrared image 2, it is preferably 200 W/m·K or more, and more preferably 390 W/m·K or more.

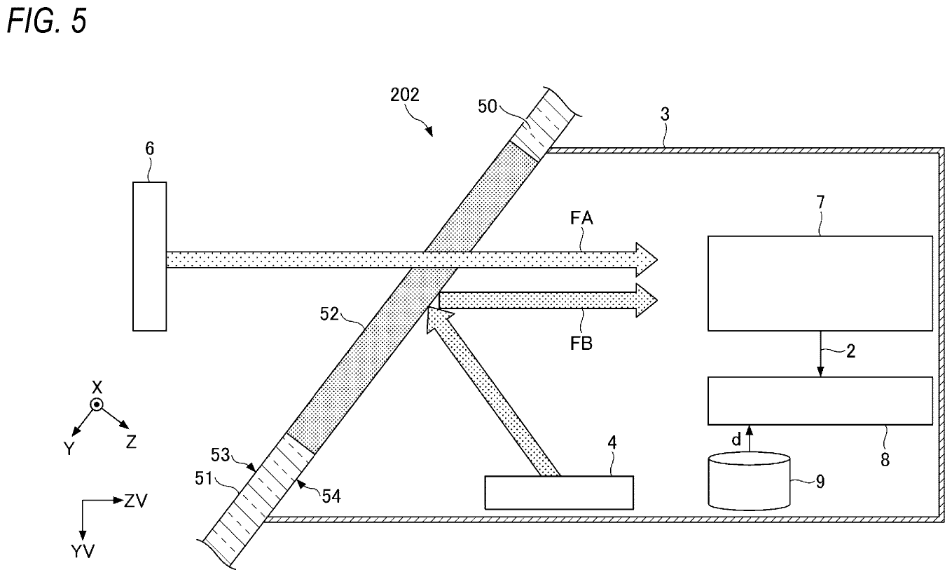

FIG. 5 is a cross-sectional view of a camera-equipped vehicular window glass according to a second embodiment. A camera-equipped window glass 202 illustrated in FIG. 5 is an example of the camera-equipped vehicular window glass. In the second embodiment, the description of the configuration, function, and effect same as those of the above embodiment is omitted or simplified by referring to the above description.

The camera-equipped window glass 202 includes a memory 9 that stores correction data d for reducing the noise 5 mixed in the far-infrared image 2. The memory 9 is preferably a nonvolatile memory, and may be an auxiliary storage device such as a hard disk. The image-processing unit 8 reduces the noise 5 mixed in the far-infrared image 2 by using the correction data d read from the memory 9.

By including the memory 9, the camera-equipped window glass 202 can store the correction data d created in advance for correction processing of reducing the noise 5. For example, the camera-equipped window glass 202 can store, in the memory 9, the correction data d created at an appropriate timing, such as at the time of factory shipment before vehicle attachment, at the time of factory shipment after vehicle attachment, or after shipment.

The correction data d includes, for example, mask data (hereinafter, also referred to as “mask data dm”) of the noise 5 mixed in the far-infrared image 2. The image-processing unit 8 reduces the noise 5 by performing mask-processing on the far-infrared image 2 by using the mask data dm read from the memory 9. The mask data is also referred to as a mask image. Note that, the mask-processing of masking the noise 5 mixed in the far-infrared image 2 by using the mask data dm may be performed by using a known method.

The mask data dm is, for example, data of the far-infrared ray FB detected in advance by the far-infrared camera 7. The image-processing unit 8 can acquire the far-infrared image 2 in which the noise 5 generated by the far-infrared ray FB is reduced by performing mask-processing of subtracting the mask data dm, which is equal to the data of the far-infrared ray FB, from the far-infrared image 2 including the far-infrared ray FA and the far-infrared ray FB.

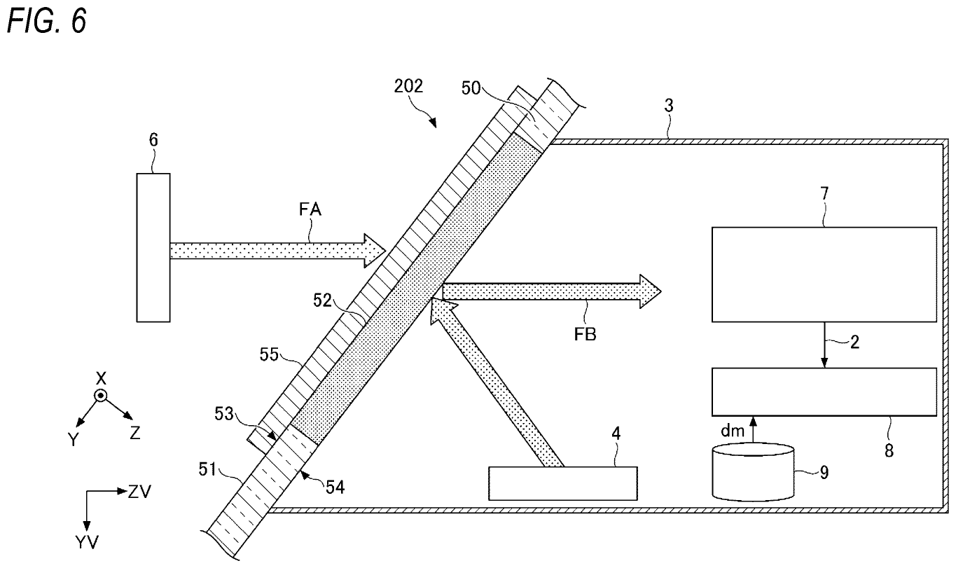

FIG. 6 is a diagram illustrating an example of a creation status of the correction data d (mask data dm). A cover 55 covering the second region 52 from an outer surface 53 side shields the far-infrared ray FA coming from the outside of the vehicle. The cover 55 is, for example, a mirror that shields the far-infrared ray FA coming from the outside of the vehicle, or may be a shielding member that shields the far-infrared ray FA, other than the mirror.

The cover 55 is disposed in the second region 52 from the outer surface 53 side at a timing such as before the vehicle travels. The far-infrared ray detected by the far-infrared camera 7 in a state where the cover 55 is disposed is the far-infrared ray FB radiated from the object 4. The image-processing unit 8 stores, in the memory 9, as the mask data dm, data of the far-infrared ray (far-infrared ray FB) detected by the far-infrared camera 7 in a state where the cover 55 covers the second region 52. In the case where the mask data dm is already stored in the memory 9, the image-processing unit 8 may update the mask data dm stored in the memory 9 to the data of the far-infrared ray FB detected by the far-infrared camera 7 in a state where the cover 55 covers the second region 52. An update timing for the mask data dm may be arbitrary timing, a specific timing, or a periodic timing (the same applies to examples to be described later).

The image-processing unit 8 reduces the noise 5 by performing mask-processing on the far-infrared image 2 by using the updated mask data dm. By using the updated mask data dm, the effect of reducing the noise 5 is ensured even when a range or intensity of the far-infrared ray FB incident on the far-infrared camera 7 changes due to a solar radiation status during traveling of the vehicle or due to deterioration over time.

The image-processing unit 8 can reduce the noise 5 mixed in the far-infrared image 2 by performing the mask-processing on the far-infrared image 2 by using the mask data dm created in advance as described above. Note that, the far-infrared ray FA arriving from the outside of the vehicle at the time of generating the mask data dm may be blocked by means different from the cover 55. For example, the far-infrared ray FA may be blocked by placing the camera-equipped window glass 202 in a dark room.

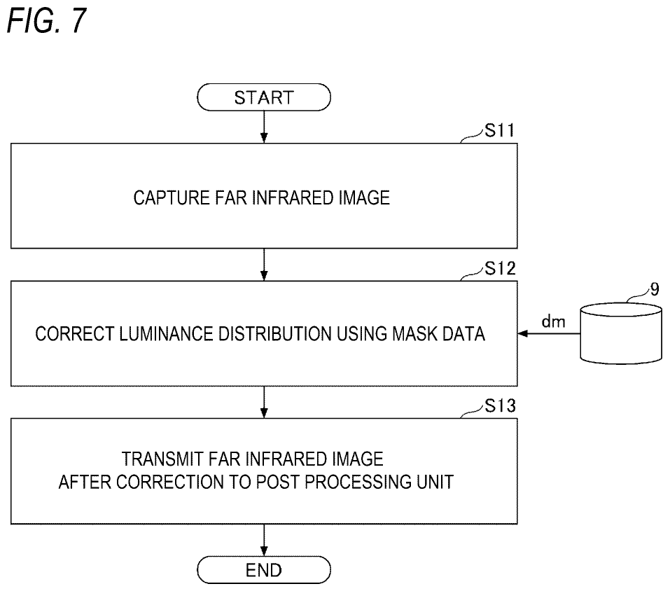

FIG. 7 is a flowchart illustrating a first example of an image-processing method executed by the image-processing unit 8. In step S11, the image-processing unit 8 acquires the far-infrared image 2 captured by the far-infrared camera 7 that detects the far-infrared ray FA. The acquired far-infrared image 2 includes not only data of the far-infrared ray FA but also data of the far-infrared ray FB. In step S12, the image-processing unit 8 corrects a luminance distribution of the far-infrared image 2 by using the mask data dm and performs mask-processing on the noise 5 mixed in the far-infrared image 2. Accordingly, the image-processing unit 8 can reduce the noise 5 that is mixed in the far-infrared image 2 due to direct incidence of the far-infrared ray FB or by reflecting the far-infrared ray FB on the second region 52 or the like. In step S13, the image-processing unit 8 transmits the far-infrared image 2 with reduced noise 5 to a post-processing unit. Accordingly, the post-processing unit can execute predetermined processing on the far-infrared image 2 with reduced noise 5.

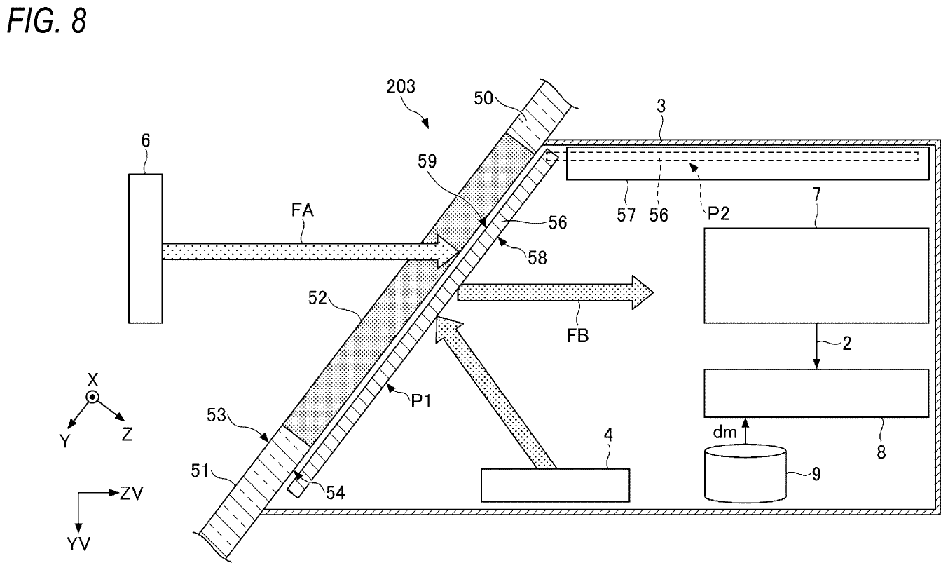

FIG. 8 is a cross-sectional view of a camera-equipped vehicular window glass according to a third embodiment. A camera-equipped window glass 203 illustrated in FIG. 8 is an example of the camera-equipped vehicular window glass. In the third embodiment, the description of the configuration, function, and effect same as those of the above embodiments is omitted or simplified by referring to the above description.

The camera-equipped window glass 203 includes a reflection plate 56 and a drive mechanism 57 for creating the mask data dm. The reflection plate 56 has a shielding surface 59 that shields a far-infrared ray and a reflection surface 58 that reflects a far-infrared ray. Note that, the shielding surface 59 may be a reflection surface as long as it has a function of shielding a far-infrared ray. The drive mechanism 57 moves the reflection plate 56 to a first position P1. The first position P1 represents a position where the far-infrared ray FA is shielded by the shielding surface 59 and the far-infrared ray FB is reflected by the reflection surface 58 and incident on the far-infrared camera 7.

The image-processing unit 8 stores, in the memory 9, as the mask data dm, data of the far-infrared ray (far-infrared ray FB) detected by the far-infrared camera 7 in a state where the reflection plate 56 is moved to the first position P1 by the drive mechanism 57. In the case where the mask data dm is already stored in the memory 9, the image-processing unit 8 may update the mask data dm stored in the memory 9 to the data of the far-infrared ray detected by the far-infrared camera 7 in a state where the reflection plate 56 is at the first position P1.

In this way, in the case where the camera-equipped window glass 203 includes the drive mechanism 57 that moves the reflection plate 56 to the first position P1, the image-processing unit 8 can automatically create and update the mask data dm. The drive mechanism 57 includes, for example, a motor that moves the reflection plate 56 in accordance with a command signal from the image-processing unit 8.

The reflection plate 56 is a flat plate in this example, but is not particularly limited as long as it has a shape movable to the first position P1. For example, the reflection plate 56 may be a plate foldable into a diaphragm shutter shape or a bellows shape, a sheet that can be stored in a roll shape, a cylindrical mirror surface, or the like.

The drive mechanism 57 moves, for example, the flat reflection plate 56 or the reflection plate 56 foldable into a bellows shape to the first position P1 along the X direction or the Y direction. Alternatively, the drive mechanism 57 may move the reflection plate 56 to the first position P1 by closing a diaphragm opening of the reflection plate 56 having a diaphragm shutter shape. Alternatively, the drive mechanism 57 may move the reflection plate 56 to the first position P1 by pulling out the reflection plate 56 stored in a roll shape. Alternatively, the drive mechanism 57 may move the reflection plate 56 to the first position P1 by rotating the reflection plate 56 disposed in a cylindrical shape about a central axis. Note that, the illustrated position of the first position P1 is merely an example.

The drive mechanism 57 may move the reflection plate 56 to a second position P2 where the far-infrared ray FA is incident on the far-infrared camera 7 without being shielded by the shielding surface 59 and the far-infrared ray FB is reflected by the second region 52 and incident on the far-infrared camera 7. The image-processing unit 8 may reduce the noise 5 by performing mask-processing on the far-infrared image 2 by using the mask data dm in a state where the reflection plate 56 is moved to the second position P2 by the drive mechanism 57. In this way, since the camera-equipped window glass 203 includes the drive mechanism 57 that moves the reflection plate 56 to the second position P2, the image-processing unit 8 can perform mask-processing on the far-infrared image 2 including the data of the far-infrared ray FA and the data of the far-infrared ray FB without being hindered by the reflection plate 56.

The drive mechanism 57 moves, for example, the flat reflection plate 56 or the reflection plate 56 foldable into a bellows shape to the second position P2 along the X direction, the Y direction, or the ZV direction. The drive mechanism 57 may move the reflection plate 56 to the second position P2 by opening the diaphragm opening of the reflection plate 56 having a diaphragm shutter shape. The drive mechanism 57 may move the reflection plate 56 to the second position P2 by winding the reflection plate 56 that can be stored in a roll shape. Alternatively, the drive mechanism 57 may move the reflection plate 56 to the second position P2 by rotating the reflection plate 56 disposed in a cylindrical shape about the central axis. Note that, the illustrated position of the second position P2 is merely an example.

The image-processing unit 8 may update the mask data dm by repeating a movement of the reflection plate 56 to the first position P1 and a movement of the reflection plate 56 to the second position P2 by the drive mechanism 57. Accordingly, the effect of reducing the noise is ensured even when the range or intensity of the far-infrared ray FB incident on the far-infrared camera 7 changes due to a solar radiation status during traveling of the vehicle or due to deterioration over time.

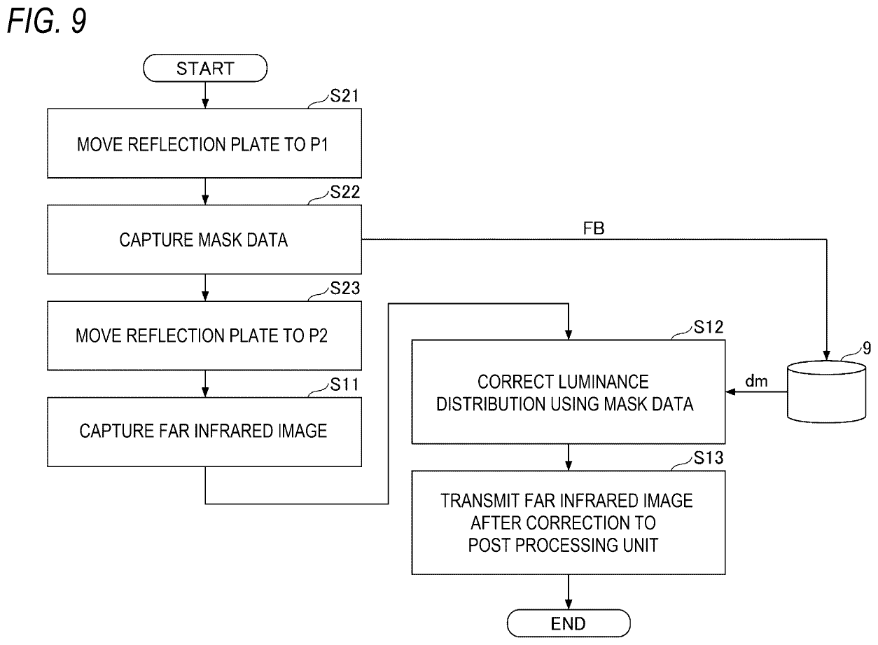

FIG. 9 is a flowchart illustrating a second example of the image-processing method executed by the image-processing unit 8. In step S21, the image-processing unit 8 controls the drive mechanism 57 to move the reflection plate 56 to the first position P1. In step S22, the image-processing unit 8 stores, in the memory 9, as the mask data dm, the data of the far-infrared ray (far-infrared ray FB) detected by the far-infrared camera 7 in a state where the reflection plate 56 is moved to the first position P1. In step S23, the image-processing unit 8 controls the drive mechanism 57 to move the reflection plate 56 to the second position P2. Steps S11, S12, and S13 may be the same as the image-processing method in FIG. 7.

According to the image-processing method in FIG. 9, the image-processing unit 8 can automatically create and update the mask data dm and perform mask-processing on the far-infrared image 2 by using the updated mask data dm. Specific examples of an update cycle of the mask data dm include every start of vehicle traveling and every fixed time.

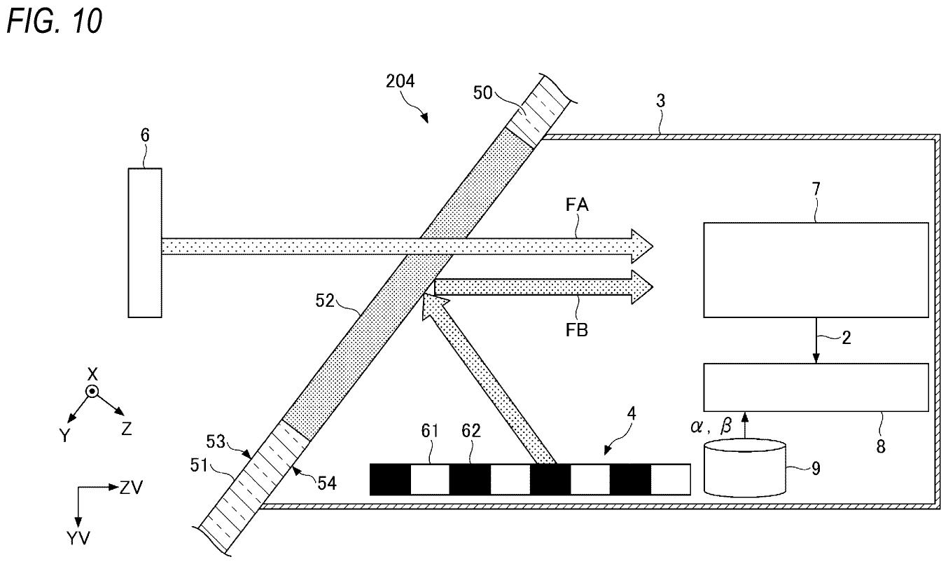

FIG. 10 is a cross-sectional view of a camera-equipped vehicular window glass according to a fourth embodiment. A camera-equipped window glass 204 illustrated in FIG. 10 is an example of the camera-equipped vehicular window glass. In the fourth embodiment, the description of the configuration, function, and effect same as those of the above embodiments is omitted or simplified by referring to the above description.

The object 4 may have a first radiation surface 61 that radiates the far-infrared ray FB at a first radiation rate α and a second radiation surface 62 that radiates the far-infrared ray FB at a second radiation rate β different from the first radiation rate a. Alternatively, a far-infrared-transmitting filter having the first radiation surface 61 that radiates a far-infrared ray at the first radiation rate α and the second radiation surface 62 that radiates a far-infrared ray at the second radiation rate β may be disposed between the object 4 that radiates the far-infrared ray FB and 30 the second region 52. In a preferred embodiment, as illustrated in FIG. 10, the first radiation surface 61 and the second radiation surface 62 are attached to the object 4 itself. The correction data d stored in the memory 9 includes data of the first radiation rate α and data of the second radiation rate β. The memory 9 stores the data of the first radiation rate α and the data of the second radiation rate β in advance.

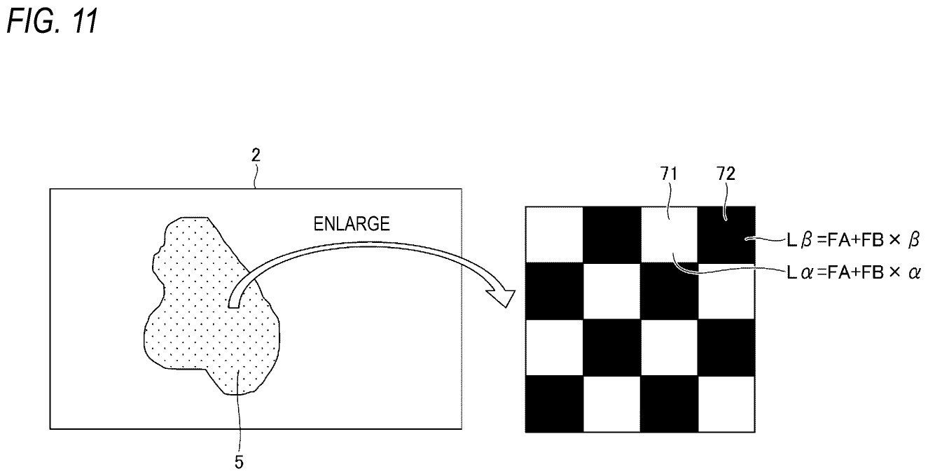

FIG. 11 is a diagram illustrating an example of an image-processing method applied to the fourth embodiment. FIG. 11 illustrates a state where the noise 5 (reflection image) generated by the far-infrared ray FB radiated from the object 4 is mixed in the far-infrared image 2. When the far-infrared image 2 is viewed in an enlarged manner, the far-infrared image 2 includes at least one first pixel region 71 and at least one second pixel region 72. The first pixel region 71 is a region in which at least the second far-infrared ray FB radiated from the first radiation surface 61 of the object 4 at the first radiation rate α is captured. The second pixel region 72 is a region in which at least the second far-infrared ray FB radiated from the second radiation surface 62 of the object 4 at the second radiation rate β is captured.

The first pixel region 71 is a single pixel having luminance data Lα generated by mixing the far-infrared ray FA incident through the second region 52 and the far-infrared ray FB incident after being radiated from the first radiation surface 61 at the first radiation rate a. The second pixel region 72 is a single pixel having luminance data Lβ generated by mixing the far-infrared ray FA incident through the second region 52 and the far-infrared ray FB incident after being radiated from the second radiation surface 62 at the second radiation rate β. In the case where the first radiation surface 61 and the second radiation surface 62 are alternately arranged in a lattice shape, the first pixel region 71 and the second pixel region 72 also alternately appear in a lattice shape.

The luminance data Lα and the luminance data Lβ are expressed by

$$L α = FA + FB \times α \qquad Equation 1$$

$$L β = FA + FB \times β . \qquad Equation 2$$

According to the Equation 1 and the Equation 2, difference data (Lα-Lβ) between the luminance data Lα and the luminance data Lβ is expressed by

$$L α - L β = FB \times ( α - β ) . \qquad Equation 3$$

The image-processing unit 8 measures the luminance data Lα and the luminance data Lβ. The first radiation rate α and the second radiation rate β are stored in the memory 9 in advance. Therefore, the image-processing unit 8 can extract the far-infrared ray FB by substituting the measured value of the luminance data La, the measured value of the luminance data Lβ, the first radiation rate ≢, and the second radiation rate β into the Equation 3. In this way, the image-processing unit 8 can extract the far-infrared ray FB by using the difference data between the luminance data Lα and the luminance data Lβ, the first radiation rate α, and the second radiation rate β.

The image-processing unit 8 calculates the difference data (Lα-Lβ) for, for example, the first pixel region 71 and the second pixel region 72 adjacent to each other. Accordingly, the image-processing unit 8 can extract the far-infrared ray FB with high accuracy as compared with the case of using the difference data (Lα-Lβ) for the first pixel region 71 and the second pixel region 72 which are not adjacent to each other and are separated from each other.

The image-processing unit 8 may extract the far-infrared ray FA by subtracting a product of the extracted data of the far-infrared ray FB and the data of the first radiation rate a from the luminance data Lα of the first pixel region 71 by using the Equation 1. Alternatively, the image-processing unit 8 may extract the far-infrared ray FA by subtracting a product of the extracted data of the far-infrared ray FB and the data of the second radiation rate β from the luminance data Lβof the second pixel region 72 by using the Equation 2.

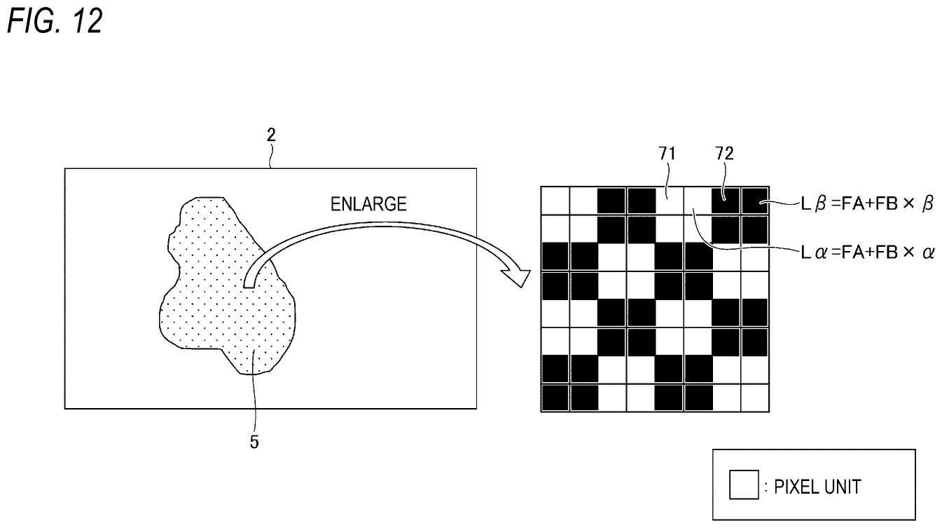

FIG. 12 is a diagram illustrating another example of the image-processing method applied to the fourth embodiment. One first pixel region 71 illustrated in FIG. 12 is different from the case in FIG. 11, which is a single pixel, in that a plurality of (four in this example) pixels having the same luminance data Lα are provided. Similarly, one second pixel region 72 illustrated in FIG. 12 is different from the case in FIG. 11, which is a single pixel, in that a plurality of (four in this example) pixels having the same luminance data Lβ are provided.

That is, the number of pixels included in one first pixel region 71 may be one or more, and the number of pixels included in one second pixel region 72 may be one or more. Also in the case of FIG. 12, the image-processing unit 8 can extract the far-infrared ray FB and the far-infrared ray FA as in the description regarding FIG. 11. The image-processing unit 8 may store, in the memory 9, the extracted data of the far-infrared ray FB as the mask data dm described above.

In the fourth embodiment, the object 4 has a plurality of radiation surfaces having different radiation rates of far-infrared rays. An arrangement pattern of the plurality of radiation surfaces is not limited to a lattice shape, and may be another pattern.

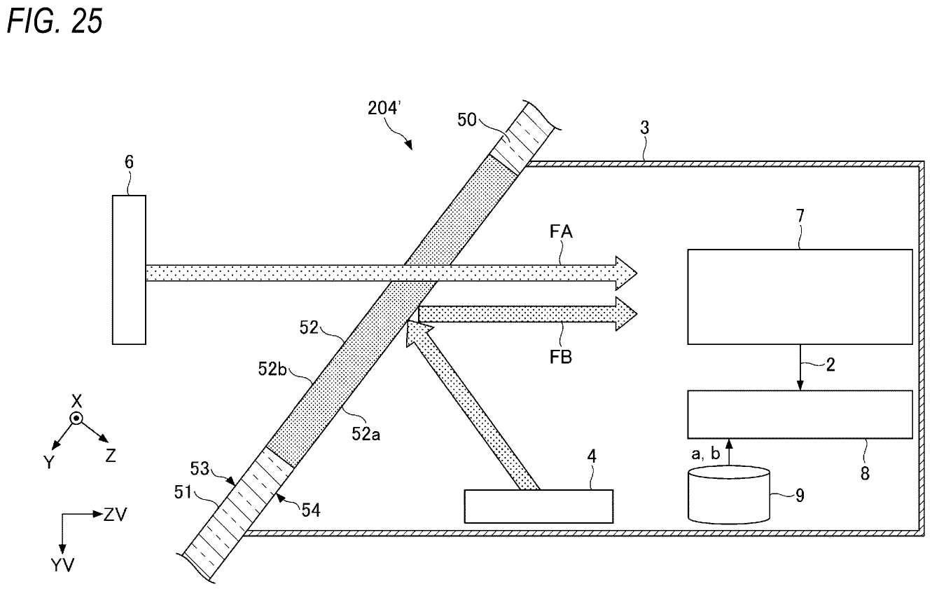

A camera-equipped window glass 204′ illustrated in FIG. 25 is another example of the camera-equipped vehicular window glass according to the fourth embodiment. The description of the configuration, function, and effect same as those of the above embodiments is omitted or simplified by referring to the above description.

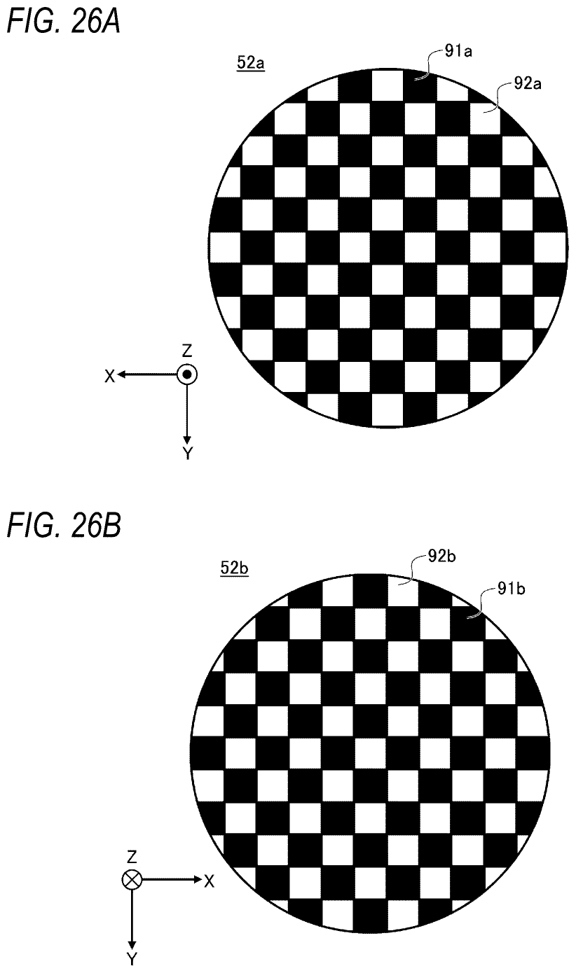

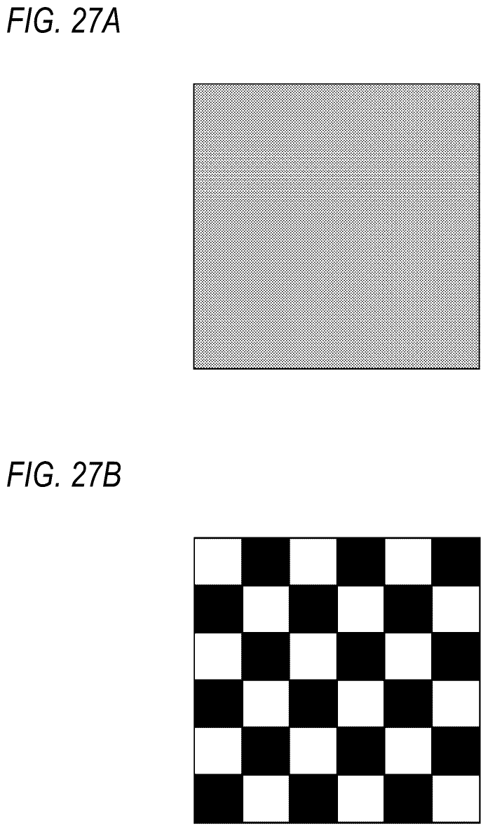

The second region 52 has a vehicle inner surface 52a and a vehicle outer surface 52b. FIG. 26A is a schematic view of the vehicle inner surface 52a as viewed from the vehicle inner side. The vehicle inner surface 52a has a first reflection surface 91a that reflects the far-infrared ray FB at a first reflectance a and a second reflection surface 92a that reflects the far-infrared ray FB at a second reflectance b different from the first reflectance a. FIG. 26B is a schematic view of the vehicle outer surface 52b viewed from the vehicle outer side. The vehicle outer surface 52b has a first transmission surface 91b that transmits the far-infrared ray FA at a first transmittance a′ and a second transmission surface 92b that transmits the far-infrared ray FA at a second transmittance b′ different from the first transmittance a′. A positional relationship between the first reflection surface 91a on the vehicle inner surface 52a and the second transmission surface 92b on the vehicle outer surface 52b as viewed from the far-infrared camera 7 is a correspondence relationship. Similarly, a positional relationship between the second reflection surface 92a on the vehicle inner surface 52a and the first transmission surface 91b on the vehicle outer surface 52b as viewed from the far-infrared camera 7 is a correspondence relationship. As illustrated in FIG. 27A, a relationship between the first reflectance a, the second reflectance b, the first transmittance a′, and the second transmittance b′is set such that pixel values viewed from a far-infrared camera 7 side are uniform. Accordingly, a contrast ratio of the far-infrared image obtained from the far-infrared ray FA transmitted through the second region 52 is maintained as illustrated in FIG. 27A, but a contrast difference occurs in the far-infrared image obtained from the far-infrared ray FB reflected by the vehicle inner surface 52a due to a difference between the first reflectance a and the second reflectance b, as illustrated in FIG. 27B. The correction data d stored in the memory 9 includes data of the first reflectance a and data of the second reflectance b. The memory 9 stores the data of the first reflectance a and the data of the second reflectance b in advance.

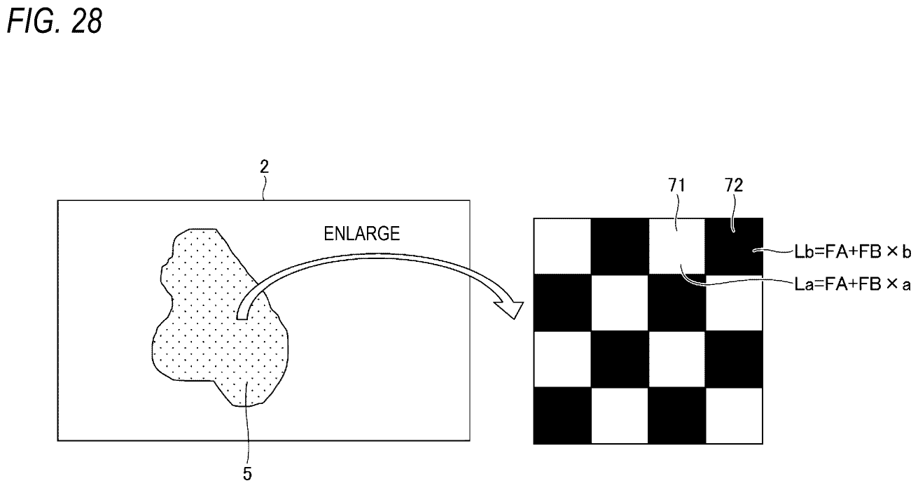

FIG. 28 is a diagram illustrating another example of the image-processing method applied to the fourth embodiment. FIG. 28 illustrates a state where the noise 5 (reflection image) generated by the far-infrared ray FB radiated from the object 4 is mixed in the far-infrared image 2. When the far-infrared image 2 is viewed in an enlarged manner, the far-infrared image 2 includes at least one first pixel region 71 and at least one second pixel region 72. The first pixel region 71 is a region in which at least an image of the second far-infrared ray FB radiated from the object 4 and reflected at the first reflectance a is captured. The second pixel region 72 is a region in which at least an image of the second far-infrared ray FB radiated from the object 4 and reflected at the second reflectance b is captured.

The first pixel region 71 is a single pixel having luminance data La generated by mixing the far-infrared ray FA incident through the second region 52 and the far-infrared ray FB incident after being reflected at the first reflectance a. The second pixel region 72 is a single pixel having luminance data Lb generated by mixing the far-infrared ray FA incident through the second region 52 and the far-infrared ray FB incident after being reflected at the second reflectance b. In the case where the first reflection surface 91a and the second reflection surface 92a are alternately arranged in a lattice shape on the vehicle inner surface 52a, the first pixel region 71 and the second pixel region 72 also alternately appear in a lattice shape.

The luminance data La and the luminance data Lb are expressed by

$$La = FA + FB \times a \qquad Equation 4$$

$$Lb = FA + FB \times b . \qquad Equation 5$$

According to the Equation 4 and the Equation 5, difference data (La-Lb) between the luminance data La and the luminance data Lb is expressed by

$$La - Lb = FB \times ( a - b ) . \qquad Equation 6$$

The image-processing unit 8 measures the luminance data La and the luminance data Lb. The first reflectance a and the second reflectance b are stored in the memory 9 in advance. Therefore, the image-processing unit 8 can extract the far-infrared ray FB by substituting the measured value of the luminance data La, the measured value of the luminance data Lb, the first reflectance a, and the second reflectance b into the Equation 6. In this way, the image- processing unit 8 can extract the far-infrared ray FB by using the difference data between the luminance data La and the luminance data Lb, the first reflectance a, and the second reflectance b.

The image-processing unit 8 calculates the difference data (La-Lb) for, for example, the first pixel region 71 and the second pixel region 72 adjacent to each other. Accordingly, the image-processing unit 8 can extract the far-infrared ray FB with high accuracy as compared with the case of using the difference data (La-Lb) for the first pixel region 71 and the second pixel region 72 which are not adjacent to each other and are separated from each other.

The image-processing unit 8 may extract the far-infrared ray FA by subtracting a product of the extracted data of the far-infrared ray FB and the data of the first reflectance a from the luminance data La of the first pixel region 71 by using the Equation 4. Alternatively, the image-processing unit 8 may extract the far-infrared ray FA by subtracting a product of the extracted data of the far-infrared ray FB and the data of the second reflectance b from the luminance data Lb of the second pixel region 72 by using the Equation 5.

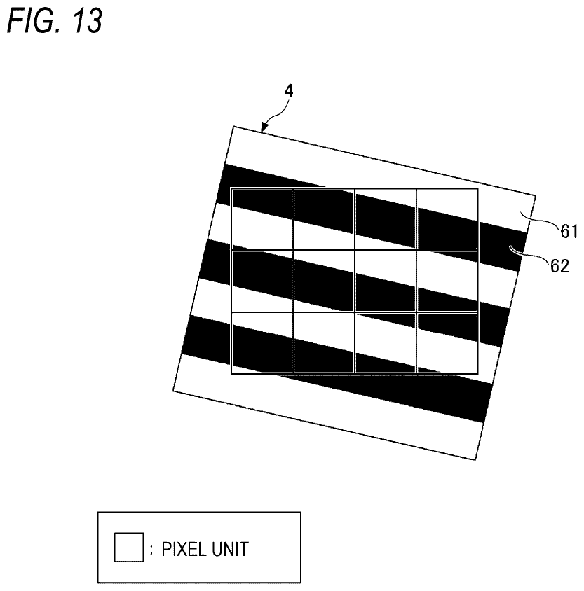

FIG. 13 is a diagram illustrating an example of the arrangement pattern of a plurality of radiation surfaces having different radiation rates of far-infrared rays. The arrangement pattern of the plurality of radiation surfaces illustrated in FIG. 13 is a stripe shape. By adopting a stripe pattern, adjustment of positions of the plurality of radiation surfaces with respect to the pixels in the far-infrared image 2 is unnecessary or simplified, and thus the production is facilitated. The object 4 illustrated in FIG. 13 has the first radiation surface 61 that radiates the far-infrared ray FB at the first radiation rate a and the second radiation surface 62 that radiates the far-infrared ray FB at the second radiation rate B different from the first radiation rate α.

In the case of the stripe pattern, it is important that a stripe direction of the noise 5 reflected in the far-infrared image 2 is non-parallel to the vertical or horizontal arrangement direction of a plurality of pixels. The reason is to prevent the adjacent pixels from including the far-infrared rays FB radiated at the same radiation rate.

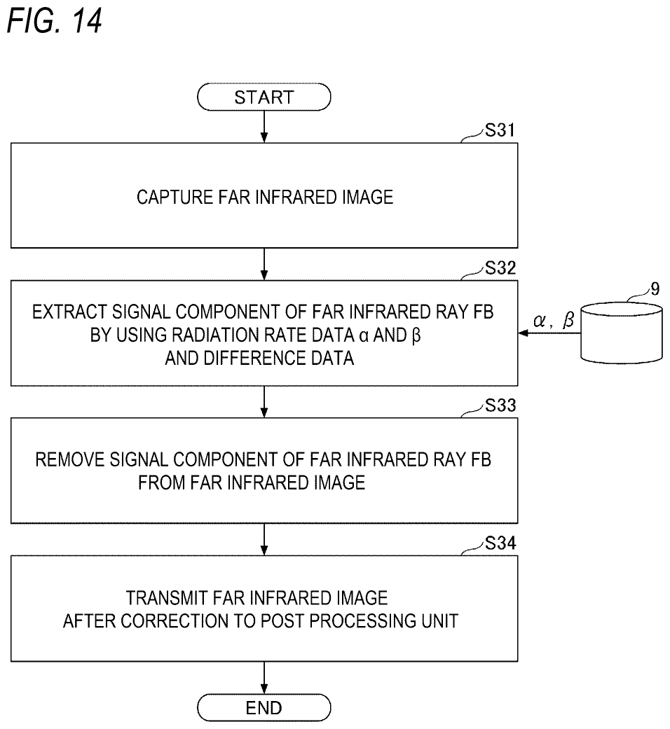

FIG. 14 is a flowchart illustrating an example of the image-processing method applied to the fourth embodiment. In step S31, the image-processing unit 8 acquires the far-infrared image 2 captured by the far-infrared camera 7 that detects the far-infrared ray FA. The acquired far-infrared image 2 includes not only the data of the far-infrared ray FA but also the data of the far-infrared ray FB. In step S32, the image-processing unit 8 extracts a signal component of the far-infrared ray FB by using, for example, the difference data (Lα-Lβ) for the first pixel region 71 and the second pixel region 72 adjacent to each other and the first radiation rate α and the second radiation rate β stored in advance in the memory 9.

In step S33, the image-processing unit 8 generates the far-infrared image 2 with reduced noise 5 by removing the signal component of the far-infrared ray FB extracted in step S32 from the far-infrared image 2 acquired in step S31. In step S34, the image-processing unit 8 transmits the far-infrared image 2 with reduced noise 5 to a post-processing unit. Accordingly, the post-processing unit can execute predetermined processing on the far-infrared image 2 with reduced noise 5.

The above description of the image-processing method illustrated in FIG. 14 is applied to the method illustrated in FIG. 28 by replacing the difference data (Lα-Lβ) with the difference data (La-Lb), replacing the first radiation rate α with the first reflectance a, and replacing the second radiation rate β with the second reflectance b.

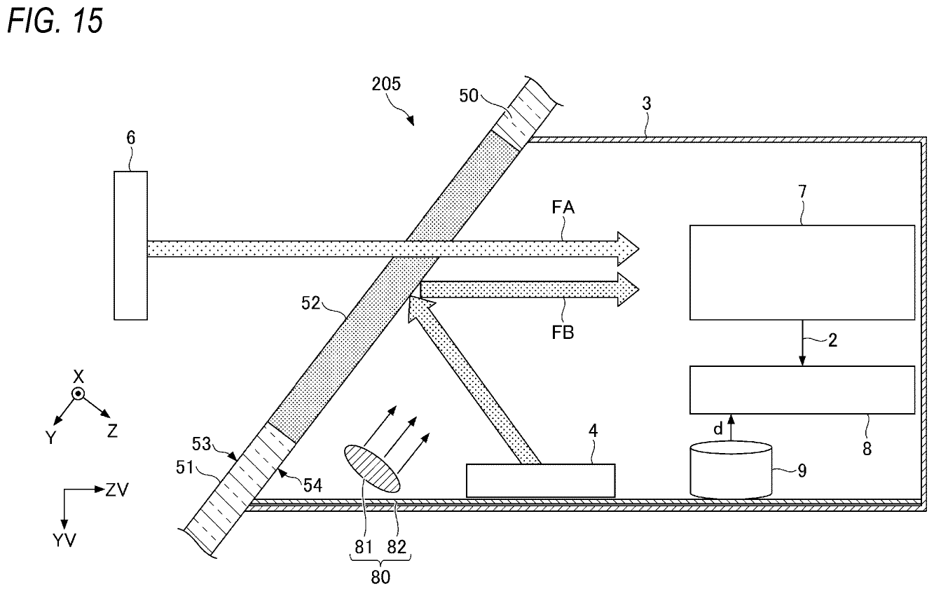

FIG. 15 is a cross-sectional view of a camera-equipped vehicular window glass according to a fifth embodiment. A camera-equipped window glass 205 illustrated in FIG. 15 is an example of the camera-equipped vehicular window glass. In the fifth embodiment, the description of the configuration, function, and effect same as those of the above embodiments is omitted or simplified by referring to the above description.

The camera-equipped window glass 205 includes a temperature control mechanism 80 that controls the temperature of the object 4. By providing the temperature control mechanism 80, the temperature distribution of the object 4 approaches uniformity, and thus the noise 5 mixed in the far-infrared image 2 is reduced.

The temperature control mechanism 80 may include, for example, a blower 81 that blows air to the object 4. Since the object 4 is uniformly cooled by the air blown by the blower 81, the noise 5 mixed in the far-infrared image 2 is reduced.

The temperature control mechanism 80 may include, for example, a refrigerant circuit 82 through which a refrigerant for cooling the object 4 circulates. Since the object 4 is uniformly cooled by the circulation of the refrigerant, the noise 5 mixed in the far-infrared image 2 is reduced.

Next, a more specific configuration example of the camera-equipped window glass according to the present embodiment will be described.

### Vehicle

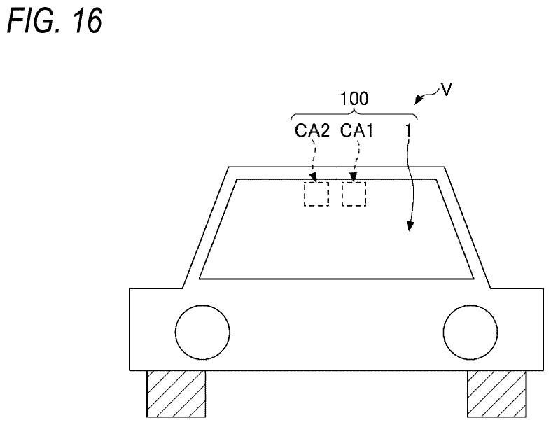

FIG. 16 is a schematic view illustrating a state where a camera-equipped window glass 1 according to the present embodiment is mounted on a vehicle V. As illustrated in FIG. 16, the window glass 1 according to the present embodiment is mounted on the vehicle V. The window glass 1 is a window member applied to a windshield of the vehicle V. That is, the window glass 1 is used as a front window of the vehicle V, in other words, a windshield glass. A far-infrared camera CA1 and a visible light camera CA2 are mounted inside (in an interior of) the vehicle V. Inside (in an interior of) the vehicle V refers to, for example, a vehicle interior in which a driver's seat is provided.

A camera unit 100 according to the present embodiment includes the window glass 1, the far-infrared camera CA1, and the visible light camera CA2. The far-infrared camera CA1 is an example of the far-infrared camera 7 described above.

The far-infrared camera CA1 is a camera that detects a far-infrared ray. The far-infrared camera CA1 captures a thermal image of the outside of the vehicle V by detecting a far-infrared ray from the outside of the vehicle V. The visible light camera CA2 is a camera that detects visible light. The visible light camera CA2 captures an image of the outside of the vehicle V by detecting visible light from the outside of the vehicle V. The camera unit 100 may further include, for example, a light detection and ranging (LiDAR) or a millimeter wave radar in addition to the far-infrared camera CA1 and the visible light camera CA2. Here, the far-infrared ray is, for example, an electromagnetic wave having a wavelength band of 8 μm or more and 13 μm or less in wavelength, and the visible light is, for example, an electromagnetic wave having a wavelength band of 360 nm or more and 830 nm or less in wavelength.

### Vehicular Window Glass

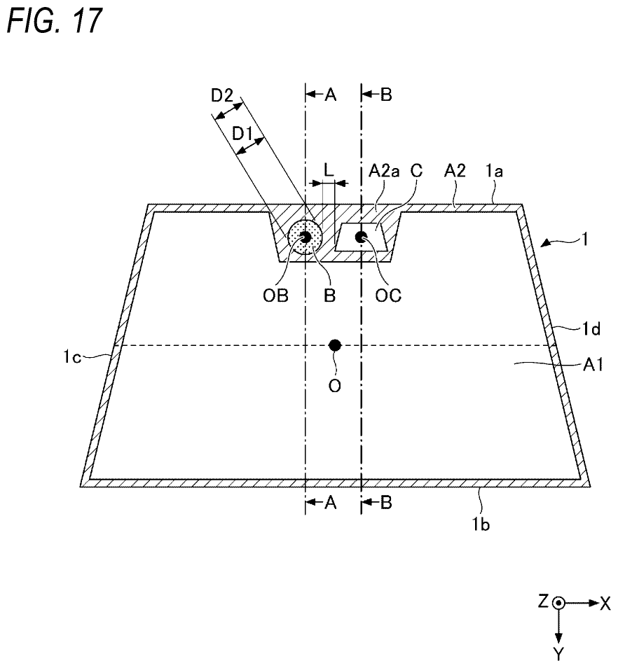

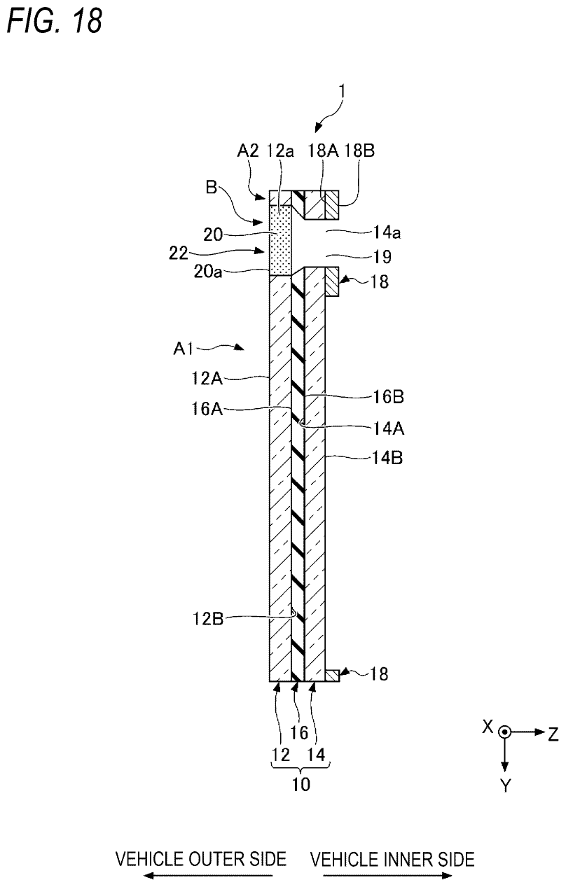

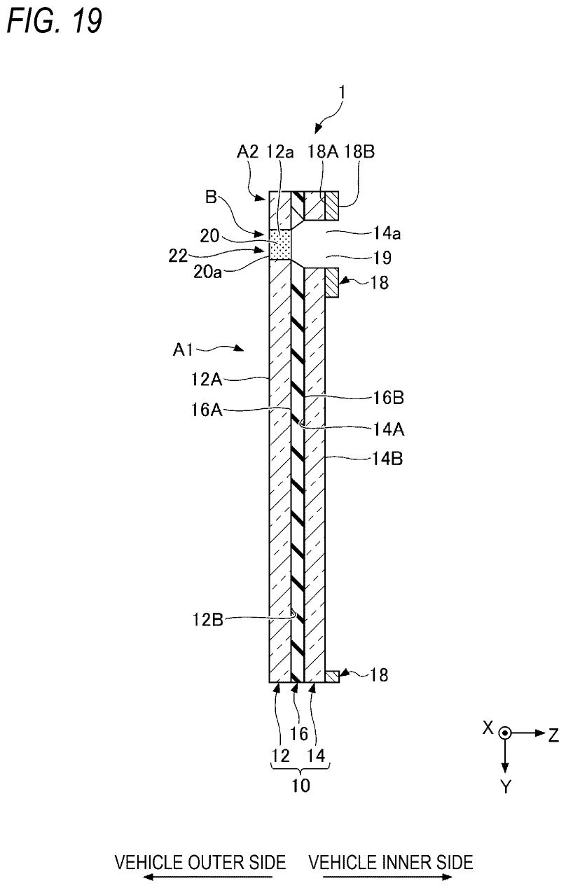

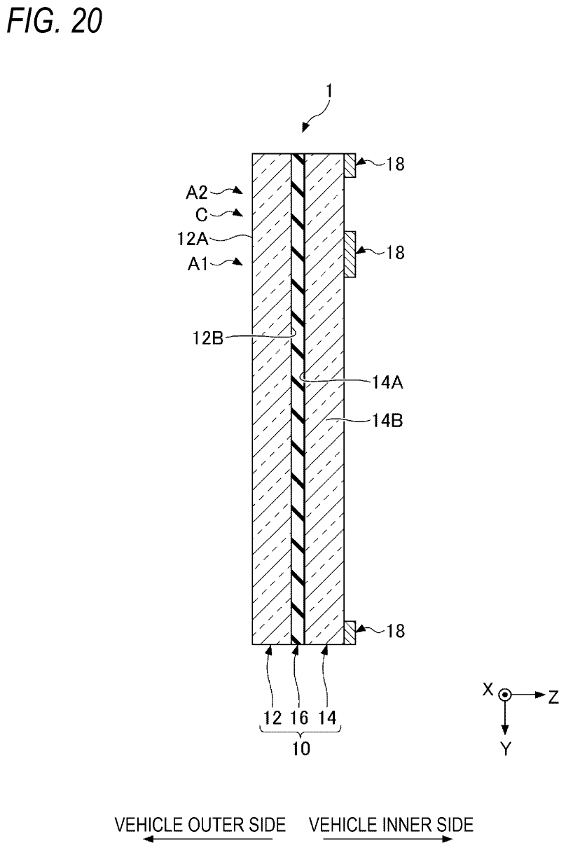

FIG. 17 is a schematic plan view of the window glass 1 according to the present embodiment. FIGS. 18 and 19 are each a cross-sectional view taken along a line A-A in FIG. 17. FIG. 18 is a cross-sectional view in the case where a glass opening dimension on a vehicle outer surface is larger than an opening dimension on a vehicle inner surface. FIG. 19 is a cross-sectional view in the case where the glass opening dimension of the vehicle inner surface is larger than the opening dimension on the vehicle outer surface. FIG. 20 is a cross-sectional view taken along a line B-B in FIG. 17. As illustrated in FIG. 17, hereinafter, an upper edge of the window glass 1 is referred to as an upper edge portion 1a, a lower edge is referred to as a lower edge portion 1b, one side edge is referred to as a side edge portion 1c, and the other side edge is referred to as a side edge portion 1d. The upper edge portion 1a is an edge portion positioned on an upper side in the vertical direction when the window glass 1 is mounted on the vehicle V. The lower edge portion 1b is an edge portion positioned on a lower side in the vertical direction when the window glass 1 is mounted on the vehicle V. The side edge portion 1c is an edge portion positioned on one side when the window glass 1 is mounted on the vehicle V. The side edge portion 1d is an edge portion positioned on the other side when the window glass 1 is mounted on the vehicle V.

Hereinafter, among directions parallel to a surface of the window glass 1, a direction from the upper edge portion 1a toward the lower edge portion 1b is defined as the Y direction (first direction), and a direction from the side edge portion 1c toward the side edge portion 1d is defined as the X direction. In the present embodiment, the X direction and the Y direction are orthogonal to each other. A direction orthogonal to the surface of the window glass 1, that is, a thickness direction of the window glass 1 is defined as the Z direction. The Z direction is, for example, a direction from the vehicle outer side to the vehicle inner side of the vehicle V when the window glass 1 is mounted on the vehicle V. The X direction and the Y direction are along the surface of the window glass 1, but may be directions in contact with the surface of the window glass 1 at a center point O of the window glass 1, for example, in the case where the surface of the window glass 1 is a curved surface. The center point O is a center position of the window glass 1 when the window glass 1 is viewed from the Z direction.

A light-transmitting region A1 and a light-shielding region A2 are formed in the window glass 1. The light-transmitting region A1 is a region occupying a central portion of the window glass 1 when viewed from the Z direction. The light-transmitting region A1 is a region for ensuring the field of view of a driver. The light-transmitting region A1 is a region that transmits visible light. The light-shielding region A2 is a region formed around the light-transmitting region A1 when viewed from the Z direction. The light-shielding region A2 is a region that shields visible light. A far-infrared-transmitting region B and a visible light-transmitting region C are formed in a light-shielding region A2a, which is a portion of the light-shielding region A2 on an upper edge portion 1a side. The light-transmitting region A1 is an example of the first region 51 described above. The far-infrared-transmitting region B is an example of the second region 52.

The far-infrared-transmitting region B is a region that transmits a far-infrared ray, and is a region in which the far-infrared camera CA1 is provided. That is, the far-infrared camera CA1 is provided at a position overlapping the far-infrared-transmitting region B when viewed from an optical axis direction of the far-infrared camera CA1. The visible light-transmitting region C is a region that transmits visible light, and is a region in which the visible light camera CA2 is provided. That is, the visible light camera CA2 is provided at a position overlapping the visible light-transmitting region C when viewed from an optical axis direction of the visible light camera CA2.

In this way, since the far-infrared-transmitting region B and the visible light-transmitting region C are formed in the light-shielding region A2, the light-shielding region A2 shields a far-infrared ray in a region other than the region in which the far-infrared-transmitting region B is formed, and shields visible light in a region other than the region in which the visible light-transmitting region C is formed. The light-shielding region A2a is formed around the far-infrared-transmitting region B and the visible light-transmitting region C. It is preferable to provide the light-shielding region A2a around in this way since various sensors are protected from sunlight. Since wirings of various sensors cannot be seen from the outside of the vehicle, it is also preferred from the viewpoint of design.

As illustrated in FIGS. 18 and 19, the window glass 1 includes a glass substrate 12 (first glass substrate), a glass substrate 14 (second glass substrate), an intermediate layer 16, and a light-shielding layer 18. In the window glass 1, the glass substrate 12, the intermediate layer 16, the glass substrate 14, and the light-shielding layer 18 are laminated in this order in the Z direction. The glass substrate 12 and the glass substrate 14 are fixed (bonded) to each other via the intermediate layer 16.

As the glass substrates 12 and 14, for example, a soda lime glass, a borosilicate glass, an aluminosilicate glass, or the like can be used. The intermediate layer 16 is an adhesive layer that bonds the glass substrate 12 and the glass substrate 14. As the intermediate layer 16, for example, a polyvinyl butyral (hereinafter also referred to as PVB) modified material, an ethylene-vinyl acetate copolymer (EVA)-based material, a urethane resin material, a vinyl chloride resin material, or the like can be used. More specifically, the glass substrate 12 has one surface 12A and the other surface 12B, and the other surface 12B is in contact with one surface 16A of the intermediate layer 16 and fixed (bonded) to the intermediate layer 16. The glass substrate 14 has one surface 14A and the other surface 14B, and the one surface 14A is in contact with the other surface 16B of the intermediate layer 16 and fixed (bonded) to the intermediate layer 16. In this way, the window glass 1 is a laminated glass in which the glass substrate 12 and the glass substrate 14 are laminated. However, the window glass 1 is not limited to a laminated glass, and may include, for example, only one of the glass substrate 12 and the glass substrate 14. In this case, the intermediate layer 16 may not be provided. Hereinafter, in the case where the glass substrates 12 and 14 are not distinguished from each other, they are referred to as a glass substrate 10. The glass substrate 10, the glass substrate 12, or the glass substrate 14 is an example of the glass plate 50 described above.

The light-shielding layer 18 has one surface 18A and the other surface 18B, and the one surface 18A is fixed in contact with the other surface 14B of the glass substrate 14. The light-shielding layer 18 is a layer that shields visible light. As the light-shielding layer 18, for example, a ceramic light-shielding layer or a light-shielding film can be used. As the ceramic light-shielding layer, for example, a ceramic layer made of a known material, such as a black ceramic layer can be used. As the light-shielding film, for example, a light-shielding polyethylene terephthalate (PET) film, a light-shielding polyethylene naphthalate (PEN) film, and a light-shielding polymethyl methacrylate (PMMA) film, or the like can be used.

In the present embodiment, in the window glass 1, a side on which the light-shielding layer 18 is provided is an inner side of the vehicle V (vehicle inner side), and the glass substrate 12 is an outer side of the vehicle V (vehicle outer side). However, the present invention is not limited thereto, and the light-shielding layer 18 may be the outer side of the vehicle V. In the case where the laminated glass containing the glass substrates 12 and 14 is used, the light-shielding layer 18 may be formed between the glass substrate 12 and the glass substrate 14.

### Light-Shielding Region

The light-shielding region A2 is formed by providing the light-shielding layer 18 on the glass substrate 10. That is, the light-shielding region A2 is a region in which the glass substrate 10 is provided with the light-shielding layer 18. That is, the light-shielding region A2 is a region in which the glass substrate 12, the intermediate layer 16, the glass substrate 14, and the light-shielding layer 18 are laminated. On the other hand, the light-transmitting region A1 is a region in which the glass substrate 10 is not provided with the light-shielding layer 18. That is, the light-transmitting region A1 is a region in which the glass substrate 12, the intermediate layer 16, and the glass substrate 14 are laminated and the light-shielding layer 18 is not laminated.

### Visible Light-Transmitting Region

As illustrated in FIG. 20, the visible light-transmitting region C is a region in which the glass substrate 10 is not provided with the light-shielding layer 18 in the Z direction, similar to the light-transmitting region A1. That is, the visible light-transmitting region C is a region in which the glass substrate 12, the intermediate layer 16, and the glass substrate 14 are laminated and the light-shielding layer 18 is not laminated.

As illustrated in FIG. 17, the visible light-transmitting region C is preferably provided in the vicinity of the far-infrared-transmitting region B. Specifically, a center of the far-infrared-transmitting region B viewed from the Z direction is defined as a center point OB, and a center of the visible light-transmitting region C viewed from the Z direction is defined as a center point OC. When the shortest distance between the far-infrared-transmitting region B (opening 19) and the visible light-transmitting region C when viewed from the Z direction is defined as a distance L, the distance L is preferably more than 0 mm and 100 mm or less, and more preferably 10 mm or more and 80 mm or less. Although not illustrated here, in the case where there are a plurality of visible light-transmitting regions C, the relationship with one of the visible light-transmitting regions C is illustrated. By setting the visible light-transmitting region C at a position within this range with respect to the far-infrared-transmitting region B, it is possible to capture images at positions close to each other by the far-infrared camera CA1 and the visible light camera CA2, to reduce an amount of perspective distortion in the visible light-transmitting region C, and to appropriately capture an image by the visible light camera CA2. By capturing images at positions close to each other by the far-infrared camera CA1 and the visible light camera CA2, a load when an arithmetic processing on data obtained from each camera is reduced, and handling of a power supply and a signal cable is suitable.

### Far-Infrared-Transmitting Member

As illustrated in FIGS. 18 and 19, the window glass 1 is formed with the opening 19 penetrating from one surface (here, the surface 12A) to the other surface (here, the surface 14B) in the Z direction. A far-infrared-transmitting member 20 is provided in the opening 19. A region in which the opening 19 is formed and the far-infrared-transmitting member 20 is provided is the far-infrared-transmitting region B. That is, the far-infrared-transmitting region B is a region in which the opening 19 and the far-infrared-transmitting member 20 disposed in the opening 19 are provided. Since the light-shielding layer 18 hardly transmits a far-infrared ray, the light-shielding layer 18 is not provided in the far-infrared-transmitting region B. That is, in the far-infrared-transmitting region B, the glass substrate 12, the intermediate layer 16, the glass substrate 14, and the light-shielding layer 18 are not provided, and the far-infrared-transmitting member 20 is provided in the formed opening 19.

Note that, it can be said that the window glass 1 includes the glass substrate 10 and the far-infrared-transmitting member 20 provided in the opening 19 of the glass substrate 10. The glass substrate 10 can also be referred to as a portion of the window glass 1 constituting the window glass, and here, for example, a configuration including the glass substrates 12 and 14, the intermediate layer 16, and the light-shielding layer 18 may be referred to as the glass substrate 10. However, as described above, the glass substrate 10 may include at least one of the glass substrate 12 and the glass substrate 14.

The far-infrared-transmitting member 20 includes a base material 22 which is a member capable of transmitting a far-infrared ray. An internal transmittance of the base material 22 with respect to light (far-infrared ray) having a wavelength of 10 μm is preferably 50% or more, more preferably 60% or more, and still more preferably 70% or more. In addition, an average internal transmittance of the base material 22 with respect to light (far-infrared ray) having a wavelength of 8 μm to 13 μm is preferably 50% or more, more preferably 60% or more, and still more preferably 70% or more. In the case where the base material 22 has the internal transmittance at 10 μm or the average internal transmittance at 8 μm to 13 μm within this numerical range, the far-infrared ray can be appropriately transmitted, and for example, the performance of the far-infrared camera CA1 can be sufficiently exhibited. Note that, here, the average internal transmittance is an average value of internal transmittances at light having respective wavelengths in the corresponding wavelength band (here, 8 μm to 13 μm).

The internal transmittance of the base material 22 is a transmittance excluding surface reflection losses on an incident side and on an emission side, and is well known in the art, and the measurement may be performed by using a usual method.

A material of the base material 22 is not particularly limited, and examples thereof include Si, Ge, ZnS, and a chalcogenide glass. It can be said that the base material 22 preferably contains at least one kind of material selected from the group consisting of Si, Ge, ZnS, and a chalcogenide glass. By using such a material for the base material 22, the far-infrared ray can be appropriately transmitted.

A preferred composition of the chalcogenide glass is a composition containing,
in at %,
Ge+Ga: 7% to 25%,
Sb: 0% to 35%,
Bi: 0% to 20%,
Zn: 0% to 20%,
Sn: 0% to 20%,
Si: 0% to 20%,
La: 0% to 20%,
S+Se+Te: 55% to 80%,
Ti: 0.005% to 0.3%,
Li+Na+K+Cs: 0% to 20%, and
F+Cl+Br+I: 0% to 20%. The glass preferably has a glass transition point (Tg) of 140° C. to 550° C.

Note that, it is more preferable to use Si or ZnS as the material of the base material 22.

In addition, the far-infrared-transmitting member 20 may be provided with a frame member (not illustrated) on an outer peripheral edge and may be attached to the opening 19 via the frame member.

### Attachment Position of Far-Infrared Camera

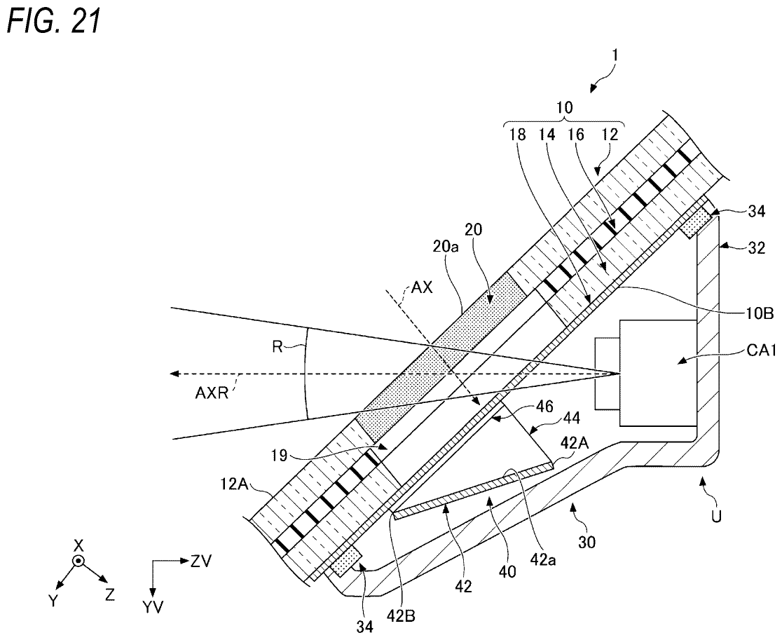

FIG. 21 is a schematic view illustrating an example of a state where the camera-equipped vehicular glass according to the present embodiment is attached to a vehicle.

The far-infrared camera CA1 is provided in the vehicle V. The far-infrared camera CA1 is provided on the vehicle inner side with respect to the far-infrared-transmitting member 20 of the window glass 1, that is, on a ZV direction side (Z direction side) with respect to the far-infrared-transmitting member 20. The far-infrared camera CA1 is provided such that an optical axis AXR passes through the far-infrared-transmitting member 20. Further, the far-infrared camera CA1 is provided such that a detection range R passes through the far-infrared-transmitting member 20. The detection range R refers to a range (imaging range) detectable by the far-infrared camera CA1, and it can be said that the far-infrared camera CA1 receives and detects the far-infrared ray incident through the detection range R. Note that, it can be said that the detection range R is a space that spreads around the optical axis AXR at a predetermined viewing angle as a distance from the far-infrared camera CA1 increases. The size and viewing angle of the detection range R may be appropriately set according to the distance and range to be detected by the far-infrared camera.

In the present embodiment, the optical axis AXR of the far-infrared camera CA1 is inclined with respect to a perpendicular AX of the far-infrared-transmitting member 20. That is, the optical axis AXR of the far-infrared camera CA1 is not along a surface 20a of the far-infrared-transmitting member 20 and is not orthogonal to the surface 20a of the far-infrared-transmitting member 20. For example, an angle formed by the optical axis AXR and the direction ZV may be smaller than an angle formed by the perpendicular AX of the far-infrared-transmitting member 20 and the direction ZV. However, the relationship between the optical axis AXR and the perpendicular AX is not limited thereto. For example, the far-infrared camera CA1 may be provided such that the optical axis AXR is along the perpendicular AX of the far-infrared-transmitting member 20.

### Configuration of Vehicular Glass

As illustrated in FIG. 21, the window glass 1 according to the present embodiment includes a cover portion 30 and a protective member 40 in addition to the glass substrate 10 and the far-infrared-transmitting member 20 provided in the opening 19 of the glass substrate 10. Note that, the far-infrared camera CA1 may be treated as being included in the window glass 1 or may be treated as a member separate from the window glass 1. In addition, for example, the far-infrared camera CA1, the cover portion 30, and the protective member 40 may treated as constituting a camera unit U attached to the window glass 1 (glass substrate 10).

The glass substrate 10 is an example of the glass plate 50 described above. The cover portion 30 is an example of the attachment 3 described above. The protective member 40 or the cover portion 30 is an example of the object 4 described above.

### Cover Portion

The cover portion 30 is provided in the vehicle V and houses a housing 32 and a fixing portion 34. The cover portion 30 is provided on the vehicle inner side with respect to the far-infrared-transmitting member 20 of the window glass 1, that is, on the ZV direction side (Z direction side) with respect to the far-infrared-transmitting member 20. The housing 32 is preferably larger than the far-infrared-transmitting member 20. The cover portion 30 includes the housing 32 and the fixing portion 34. The housing 32 houses the far-infrared camera CA1 and the protective member 40 therein. The far-infrared camera CA1 may be disposed in the housing 32 in a state of being fixed by a bracket (not illustrated). The housing 32 is attached to the glass substrate 10 such that one surface side is open and the open side faces a surface 10B of the glass substrate 10 on the vehicle inner side. The fixing portion 34 is a member that is provided in the housing 32 and that fixes the housing 32 to the glass substrate 10. The fixing portion 34 fixes the housing 32 to the glass substrate 10 in a state where the opening side of the housing 32 faces the surface 10B of the glass substrate 10.

The cover portion 30 may be made of any material, and may be, for example, a resin member that does not transmit visible light. Accordingly, the cover portion 30 can prevent the far-infrared camera CA1 or the like from being visually recognized by an occupant or the like in the vehicle V.

Note that, the cover portion 30 is not an essential component, and the far-infrared camera CA1 and the protective member 40 may not be housed in the cover portion 30. The cover portion 30 may have an integrated structure in which not only the far-infrared camera CA1 but also the visible light camera CA2 and other devices are housed. Further, a heater or the like may be provided in the cover portion 30 in order to impart a function of preventing fogging or melting snow to the glass substrate 10 and the far-infrared-transmitting member 20 on the vehicle inner side.

### Protective Member

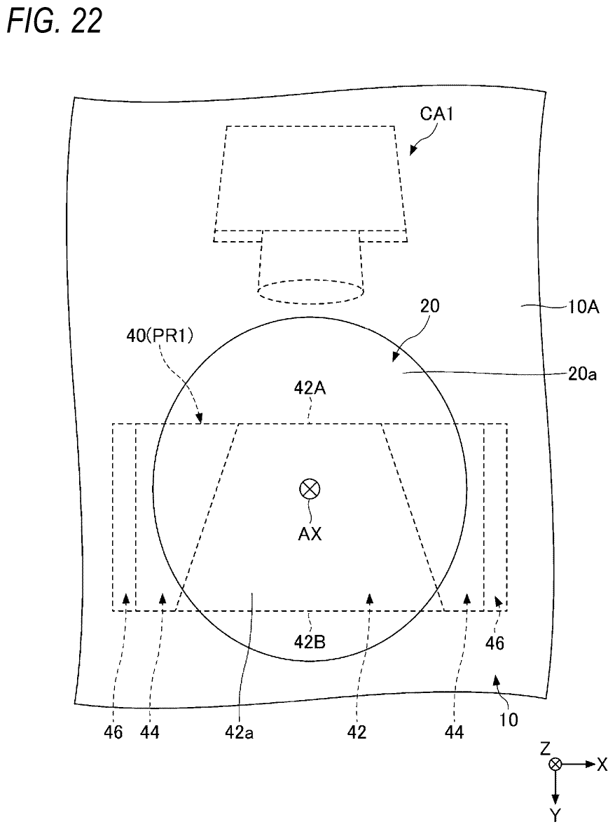

FIG. 22 is a schematic view of a far-infrared-transmitting member viewed from the vehicle outer side in a perpendicular direction. Hereinafter, the protective member 40 according to the present embodiment will be described with reference to FIGS. 21 and 22. As illustrated in FIG. 21, the protective member 40 is provided on the vehicle inner side (ZV direction side) with respect to the far-infrared-transmitting member 20. In addition, as illustrated in FIG. 22, the protective member 40 overlaps at least a part of the far-infrared-transmitting member 20 when viewed from a direction along the perpendicular line AX (a direction orthogonal to the surface 20a of the far-infrared-transmitting member 20). In other words, when viewed from the direction along the perpendicular AX, at least a part of the protective member 40 and at least a part of the far-infrared-transmitting member 20 overlap each other. Accordingly, even when a collision object from the outside of the vehicle penetrates the far-infrared-transmitting member 20, the collision object can be received by the protective member 40, and the collision object can be prevented from reaching a driver seat side. Further, at the time of a collision of the vehicle, it is possible to prevent an occupant or an object inside the vehicle from breaking through the window portion and jumping out of the vehicle. Further, as illustrated in FIG. 21, in the present embodiment, it is preferable that the protective member 40 is provided on the vehicle outer side with respect to the far-infrared camera CA1 (a direction side opposite to the direction ZV) and is provided at a position not overlapping the detection range R of the far-infrared camera CA1. That is, the protective member 40 is preferably positioned outside the detection range R without interfering with the detection range R. Accordingly, it is possible to prevent the far-infrared ray incident on the far-infrared camera CA1 from being shielded by the protective member 40, and to prevent a decrease in detection accuracy for the far-infrared ray.

More specifically, the protective member 40 includes a surface portion 42, a protruding portion 44, and a fixing portion 46. As illustrated in FIG. 22, the surface portion 42 is provided at a position overlapping at least a part of the far-infrared-transmitting member 20 when viewed from the direction along the perpendicular line AX. As illustrated in FIGS. 21 and 22, the surface portion 42 is provided at a position not overlapping the detection range R of the far-infrared camera CA1. The surface portion 42 is a plate-shaped member and extends from an end portion 42B to an end portion 42A. In the surface portion 42, a surface 42a on a far-infrared-transmitting member 20 side is inclined with respect to the direction YV (horizontal direction).

As illustrated in FIG. 21, the protruding portion 44 protrudes from both end portions of the surface portion 42 in the X direction toward a glass substrate 10 side (vehicle outer side). The fixing portion 46 is formed at a tip of the protruding portion 44 on the glass substrate 10 side. The fixing portion 46 is fixed to the surface 10B of the glass substrate 10 on the vehicle inner side. That is, the protective member 40 is fixed to the glass substrate 10 via the fixing portion 46. Note that, the protruding portion 44 and the fixing portion 46 are also provided at positions not overlapping the detection range R of the far-infrared camera CA1. However, the shapes of the protruding portion 44 and the fixing portion 46 are not limited to the above, and may be any shapes.

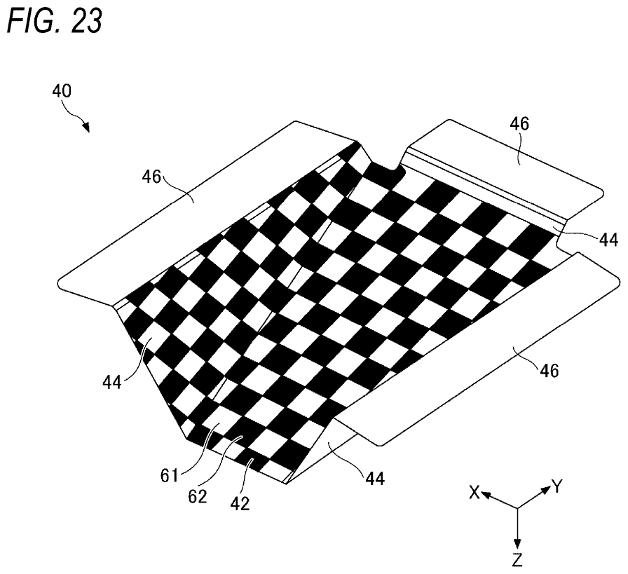

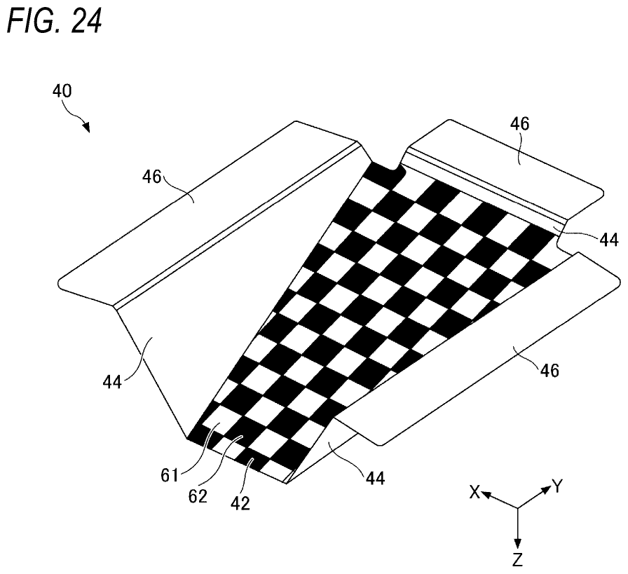

FIGS. 23 and 24 are diagrams each illustrating an example of the protective member. The protective member 40 illustrated in FIG. 23 has, on the surface portion 42 and the protruding portion 44, the first radiation surface 61 that radiates the far-infrared ray FB at the first radiation rate α and the second radiation surface 62 that radiates the far-infrared ray FB at the second radiation rate β different from the first radiation rate α. The protective member 40 illustrated in FIG. 24 has the first radiation surface 61 and the second radiation surface 62 on the surface portion 42. The functions and effects of the fourth embodiment described above can be obtained by using the protective member 40 illustrated in FIGS. 23 and 24.

In FIGS. 23 and 24, for example, a surface roughness of the second radiation surface 62 may be made larger (or smaller) than a surface roughness of the first radiation surface 61 by sandblasting processing, etching processing, or the like. Accordingly, a thermal radiation rate of the far-infrared ray reaching the surface of the far-infrared-transmitting member 20 on the vehicle inner side is different between the first radiation surface 61 and the second radiation surface 62.

Although the embodiments have been described above, the above embodiments are presented as examples, and the present invention is not limited to the above embodiments. The above embodiments can be implemented in various other forms, and various combinations, omissions, substitutions, modifications, and the like can be made without departing from the spirit of the invention. These embodiments and variations thereof are included in the scope and spirit of the invention, and are included in the scope of the invention and equivalents described in the claims.

### REFERENCE SIGNS LIST

1 window glass
1a upper edge portion
1b lower edge portion
1c, 1d side edge portion
2, 2a, 2b far-infrared image
3 attachment
4 object
5 noise
6, 6a, 6b subject
7 far-infrared camera
8 image-processing unit
9 memory
10, 12, 14 glass substrate
16 intermediate layer
18 light-shielding layer
19 opening
20 far-infrared-transmitting member
30 cover portion
40 protective member
42 surface portion
50 glass plate
51 first region
52 second region
52a vehicle inner surface
52b vehicle outer surface
53 outer surface
54 inner surface
55 cover
56 reflection plate
57 drive mechanism
58 reflection surface
59 shielding surface
61 first radiation surface
62 second radiation surface
71 first pixel region
72 second pixel region
80 temperature control mechanism
81 blower
82 refrigerant circuit
91a first reflection surface
91b first transmission surface
92a second reflection surface
92b second transmission surface
100 camera unit
201, 202, 203, 204, 204′, 205 camera-equipped window glass
A1 light-transmitting region
A2 light-shielding region
B far-infrared-transmitting region
C visible light-transmitting region
CA1 far-infrared camera
CA2 visible light camera
d correction data
V vehicle

What is claimed is:

1. A camera-equipped vehicular window glass comprising:
a glass plate formed with a first region that transmits visible light and a second region that has a far-infrared transmittance higher than a far-infrared transmittance of the first region;
a far-infrared camera configured to detect a first far-infrared ray transmitted through the second region and to capture a far-infrared image; and
an image-processing unit configured to reduce noise mixed in the far-infrared image, which is caused by a second far-infrared ray radiated from an object installed on a side where the far-infrared camera is disposed, relative to the glass plate.

2. The camera-equipped vehicular window glass according to claim 1, further comprising:
a memory configured to store correction data for reducing the noise, wherein
the image-processing unit reduces the noise by using the correction data read from the memory.

3. The camera-equipped vehicular window glass according to claim 2, wherein
the correction data includes mask data of the noise, and
the image-processing unit reduces the noise by performing mask-processing on the far-infrared image by using the mask data.

4. The camera-equipped vehicular window glass according to claim 3, further comprising:
a reflection plate having a shielding surface that shields a far-infrared ray and a reflection surface that reflects a far-infrared ray; and
a drive mechanism configured to move the reflection plate to a first position where the first far-infrared ray is shielded by the shielding surface and the second far-infrared ray is reflected by the reflection surface and incident on the far-infrared camera, wherein
the image-processing unit stores, in the memory, as the mask data, data of a far-infrared ray detected by the far-infrared camera in a state where the reflection plate is moved to the first position by the drive mechanism.

5. The camera-equipped vehicular window glass according to claim 4, wherein
the drive mechanism is configured to move the reflection plate to a second position where the first far-infrared ray is incident on the far-infrared camera without being shielded by the shielding surface and the second far-infrared ray is reflected by the second region and incident on the far-infrared camera, and
the image-processing unit reduces the noise by performing mask-processing on the far-infrared image by using the mask data in a state where the reflection plate is moved to the second position by the drive mechanism.

6. The camera-equipped vehicular window glass according to claim 5, wherein the image-processing unit updates the mask data by repeating a movement of the reflection plate to the first position and a movement of the reflection plate to the second position by the drive mechanism.

7. The camera-equipped vehicular window glass according to claim 2, wherein
the object or a far-infrared-transmitting filter disposed between the object and the second region has a first radiation surface that radiates the second far-infrared ray at a first radiation rate and a second radiation surface that radiates the second far-infrared ray at a second radiation rate different from the first radiation rate,
the correction data includes data of the first radiation rate and data of the second radiation rate,
the far-infrared image has a first pixel region in which the second far-infrared ray radiated from the first radiation surface at the first radiation rate is captured and a second pixel region in which the second far-infrared ray radiated from the second radiation surface at the second radiation rate is captured, and
the image-processing unit extracts the second far-infrared ray by using difference data between luminance data of the first pixel region and luminance data of the second pixel region, the data of the first radiation rate, and the data of the second radiation rate.

8. The camera-equipped vehicular window glass according to claim 7, wherein the image-processing unit extracts the first far-infrared ray by subtracting a product of the extracted data of the second far-infrared ray and the data of the first radiation rate from the luminance data of the first pixel region, or extracts the first far-infrared ray by subtracting a product of the extracted data of the second far-infrared ray and the data of the second radiation rate from the luminance data of the second pixel region.

9. The camera-equipped vehicular window glass according to claim 7, wherein the first pixel region and the second pixel region are adjacent to each other.

10. The camera-equipped vehicular window glass according to claim 7, wherein the number of pixels included in the first pixel region is one, and the number of pixels included in the second pixel region is one.

11. The camera-equipped vehicular window glass according to claim 2, wherein
the second region has a vehicle inner surface and a vehicle outer surface,
the vehicle inner surface has a first reflection surface that reflects the second far-infrared ray at a first reflectance and a second reflection surface that reflects the second far-infrared ray at a second reflectance different from the first reflectance,
the vehicle outer surface has a first transmission surface that transmits the first far-infrared ray at a first transmittance and a second transmission surface that transmits the first far-infrared ray at a second transmittance different from the first transmittance,
the correction data includes data of the first reflectance and data of the second reflectance,
the far-infrared image has a first pixel region in which an image of the second far-infrared ray reflected at the first reflectance is captured and a second pixel region in which an image of the second far-infrared ray reflected at the second reflectance is captured, and
the image-processing unit extracts the second far-infrared ray by using difference data between luminance data of the first pixel region and luminance data of the second pixel region, the data of the first reflectance, and the data of the second reflectance.

12. The camera-equipped vehicular window glass according to claim 11, wherein the image-processing unit extracts the first far-infrared ray by subtracting a product of the extracted data of the second far-infrared ray and the data of the first reflectance from the luminance data of the first pixel region, or extracts the first far-infrared ray by subtracting a product of the extracted data of the second far-infrared ray and the data of the second reflectance from the luminance data of the second pixel region.

13. The camera-equipped vehicular window glass according to claim 1, wherein the image-processing unit reduces the noise mixed in the far-infrared image, which is caused by the second far-infrared ray being reflected by the second region.

14. The camera-equipped vehicular window glass according to claim 1, wherein the object has a thermal conductivity of 150 W/m·K or more and 450 W/m·K or less.

15. The camera-equipped vehicular window glass according to claim 1, further comprising:
a temperature control mechanism configured to control a temperature of the object.

16. The camera-equipped vehicular window glass according to claim 15, wherein the temperature control mechanism includes a blower that blows air to the object.

17. The camera-equipped vehicular window glass according to claim 15, wherein the temperature control mechanism includes a refrigerant circuit through which a refrigerant circulates.

18. An image-processing method comprising:
capturing a far-infrared image by using a far-infrared camera that detects a first far-infrared ray transmitted through a second region that is formed on a glass plate having a first region transmitting visible light and that has a far-infrared transmittance higher than a far-infrared transmittance of the first region; and
reducing noise mixed in the far-infrared image, which is caused by a second far-infrared ray radiated from an object installed on a side where the far-infrared camera is disposed, relative to the glass plate.
